(19) United States
(12) Patent Application Publication
(10) Pub. No.: US 2023/0066566 A1
(43) Pub. Date: Mar. 2, 2023

(54) ASSOCIATION OF TRANSMISSION CONFIGURATION INDICATORS AND PRECODERS IN UPLINK TRANSMISSIONS

(71) Applicant: QUALCOMM Incorporated, San Diego, CA (US)

(72) Inventors: Fang YUAN, Beijing (CN); Wooseok NAM, San Diego, CA (US); Mostafa KHOSHNEVISAN, San Diego, CA (US); Tao LUO, San Diego, CA (US)

(21) Appl. No.: 17/794,352

(22) PCT Filed: Feb. 11, 2021
(86) PCT No.: PCT/CN2021/076608

§ 371 Date: Jul. 21, 2022

(30) Foreign Application Priority Data
Feb. 17, 2020 (CN) PCT/CN2020/075470

(51) Int. Cl. H04W 72/12; H04B 7/0456; H04B 7/06; H04L 5/00

(52) U.S. Cl. CPC H04W 72/1289; H04B 7/0456; H04B 7/0691; H04L 5/0051

(57) ABSTRACT

Various aspects of the present disclosure generally relate to wireless communication. In some aspects, a user equipment (UE) may receive downlink control information (DCI) that indicates a first transmission configuration indicator (TCI), a second TCI, and a precoding matrix. The first TCI may be associated with a first set of antenna indices of the precoding matrix and the second TCI may be associated with a second set of antenna indices of the precoding matrix. The UE may transmit an uplink transmission based at least in part on the DCI. Numerous other aspects are provided.

### CROSS-REFERENCE TO RELATED APPLICATION

This patent application claims priority to Patent Cooperation Treaty (PCT) Patent Application No. PCT/CN2020/075470, filed on Feb. 17, 2020, entitled “ASSOCIATION OF TRANSMISSION CONFIGURATION INDICATORS AND PRECODERS IN UPLINK TRANSMISSIONS,” and assigned to the assignee hereof. The disclosure of the prior application is considered part of and is incorporated by reference into this patent application.

### INTRODUCTION

Aspects of the present disclosure generally relate to wireless communication and to techniques and apparatuses for transmission configuration indicator and precoder association.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a user equipment (UE) for wireless communication includes a memory and one or more processors coupled to the memory. The memory and the one or more processors may be configured to receive downlink control information (DCI) that indicates a first transmission configuration indicator (TCI), a second TCI, and a precoding matrix, the first TCI being associated with a first set of antenna indices of the precoding matrix and the second TCI being associated with a second set of antenna indices of the precoding matrix. The memory and the one or more processors may be configured to transmit an uplink transmission based at least in part on the DCI.

In some aspects, a base station for wireless communication includes a memory and one or more processors coupled to the memory. The memory and the one or more processors may be configured to transmit DCI that indicates a first TCI, a second TCI, and a precoding matrix for UE, the first TCI being associated with a first set of antenna indices of the precoding matrix and the second TCI being associated with a second set of antenna indices of the precoding matrix. The memory and the one or more processors may be configured to receive an uplink transmission from the UE based at least in part on the DCI.

In some aspects, a UE for wireless communication includes a memory and one or more processors coupled to the memory. The memory and the one or more processors may be configured to receive DCI that indicates a first beam and a second beam for a first set of antenna indices and a second set of antenna indices that identify sounding reference signal (SRS) antenna ports associated with multiple SRS resources of multiple SRS resource sets. The memory and the one or more processors may be configured to transmit an uplink transmission based at least in part on the DCI.

In some aspects, a base station for wireless communication includes a memory and one or more processors coupled to the memory. The memory and the one or more processors may be configured to transmit, to UE, DCI that indicates a first beam and a second beam for a first set of antenna indices and a second set of antenna indices that identify SRS antenna ports associated with multiple SRS resources of multiple SRS resource sets. The memory and the one or more processors may be configured to receive an uplink transmission from the UE based at least in part on the DCI.

In some aspects, a method of wireless communication performed by UE includes receiving DCI that indicates a first TCI, a second TCI, and a precoding matrix, the first TCI being associated with a first set of antenna indices of the precoding matrix and the second TCI being associated with a second set of antenna indices of the precoding matrix. The method may include transmitting an uplink transmission based at least in part on the DCI.

In some aspects, a method of wireless communication performed by a base station includes transmitting DCI that indicates a first TCI, a second TCI, and a precoding matrix for UE, the first TCI being associated with a first set of antenna indices of the precoding matrix and the second TCI being associated with a second set of antenna indices of the precoding matrix. The method may include receiving an uplink transmission from the UE based at least in part on the DCI.

In some aspects, a method of wireless communication performed by UE includes receiving DCI that indicates a first beam and a second beam for a first set of antenna indices and a second set of antenna indices that identify SRS antenna ports associated with multiple SRS resources of multiple SRS resource sets. The method may include transmitting an uplink transmission based at least in part on the DCI.

In some aspects, a method of wireless communication performed by a base station includes transmitting, to UE, DCI that indicates a first beam and a second beam for a first set of antenna indices and a second set of antenna indices that identify SRS antenna ports associated with multiple SRS resources of multiple SRS resource sets. The method may include receiving an uplink transmission from the UE based at least in part on the DCI.

In some aspects, an apparatus for wireless communication includes means for receiving DCI that indicates a first TCI, a second TCI, and a precoding matrix, the first TCI being associated with a first set of antenna indices of the precoding matrix and the second TCI being associated with a second set of antenna indices of the precoding matrix. The apparatus may include means for transmitting an uplink transmission based at least in part on the DCI.

In some aspects, an apparatus for wireless communication includes means for transmitting DCI that indicates a first TCI, a second TCI, and a precoding matrix for UE, the first TCI being associated with a first set of antenna indices of the precoding matrix and the second TCI being associated with a second set of antenna indices of the precoding matrix. The apparatus may include means for receiving an uplink transmission from the UE based at least in part on the DCI.

In some aspects, an apparatus for wireless communication includes means for receiving DCI that indicates a first beam and a second beam for a first set of antenna indices and a second set of antenna indices that identify SRS antenna ports associated with multiple SRS resources of multiple SRS resource sets. The apparatus may include means for transmitting an uplink transmission based at least in part on the DCI.

In some aspects, an apparatus for wireless communication includes means for transmitting, to UE, DCI that indicates a first beam and a second beam for a first set of antenna indices and a second set of antenna indices that identify SRS antenna ports associated with multiple SRS resources of multiple SRS resource sets. The apparatus may include means for receiving an uplink transmission from the UE based at least in part on the DCI.

In some aspects, a non-transitory computer-readable medium storing a set of instructions for wireless communication includes one or more instructions that, when executed by one or more processors of a UE, cause the UE to receive DCI that indicates a first TCI, a second TCI, and a precoding matrix, the first TCI being associated with a first set of antenna indices of the precoding matrix and the second TCI being associated with a second set of antenna indices of the precoding matrix. The one or more instructions, when executed by the one or more processors of the UE, may cause the UE to transmit an uplink transmission based at least in part on the DCI.

In some aspects, a non-transitory computer-readable medium storing a set of instructions for wireless communication includes one or more instructions that, when executed by one or more processors of a base station, cause the base station to transmit DCI that indicates a first TCI, a second TCI, and a precoding matrix for UE, the first TCI being associated with a first set of antenna indices of the precoding matrix and the second TCI being associated with a second set of antenna indices of the precoding matrix. The one or more instructions, when executed by the one or more processors of the base station, may cause the base station to receive an uplink transmission from the UE based at least in part on the DCI.

In some aspects, a non-transitory computer-readable medium storing a set of instructions for wireless communication includes one or more instructions that, when executed by one or more processors of a UE, cause the UE to receive DCI that indicates a first beam and a second beam for a first set of antenna indices and a second set of antenna indices that identify SRS antenna ports associated with multiple SRS resources of multiple SRS resource sets. The one or more instructions, when executed by the one or more processors of the UE, may cause the UE to transmit an uplink transmission based at least in part on the DCI.

In some aspects, a non-transitory computer-readable medium storing a set of instructions for wireless communication includes one or more instructions that, when executed by one or more processors of a base station, cause the base station to transmit, to UE, DCI that indicates a first beam and a second beam for a first set of antenna indices and a second set of antenna indices that identify SRS antenna ports associated with multiple SRS resources of multiple SRS resource sets. The one or more instructions, when executed by the one or more processors of the base station, may cause the base station to receive an uplink transmission from the UE based at least in part on the DCI.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3A is a diagram illustrating an example of association of transmission configuration indicators and precoders in uplink transmissions, in accordance with the present disclosure.

FIG. 3B is a diagram illustrating an example of a multi-panel uplink transmission, in accordance with the present disclosure.

FIGS. 4A-4D are diagrams illustrating examples of association of transmission configuration indicators and precoders in uplink transmissions, in accordance with the present disclosure.

FIG. 5 is a diagram illustrating an example of SRS resource sets, in accordance with the present disclosure.

FIG. 6 is a diagram illustrating an example of reference signals in a wireless network, in accordance with the present disclosure.

FIG. 7 is a diagram illustrating an example of using beams for communications between a base station and a UE, in accordance with the present disclosure.

FIG. 8 is a diagram illustrating one or more examples of precoder matrices, in accordance with the present disclosure.

FIG. 9 is a diagram illustrating an example process performed, for example, by a UE, in accordance with the present disclosure.

FIG. 10 is a diagram illustrating an example process performed, for example, by a base station, in accordance with the present disclosure.

FIG. 11 is a diagram illustrating an example process performed, for example, by a UE, in accordance with the present disclosure.

FIG. 12 is a diagram illustrating an example process performed, for example, by a base station, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

FIG. 16 is a diagram of an example apparatus for wireless communication, in accordance with the present disclosure.

FIG. 17 is a diagram illustrating an example of a hardware implementation for an apparatus employing a processing system, in accordance with the present disclosure.

FIG. 18 is a diagram illustrating an example of an implementation of code and circuitry for an apparatus, in accordance with the present disclosure.

### DETAILED DESCRIPTION

A user equipment (UE) may transmit an uplink transmission using a beam. The beam may be indicated by a transmission configuration indicator (TCI) in downlink control information (DCI) received by the UE. The UE may generate the beam for transmitting the uplink transmission using a precoding matrix. The precoding matrix may be identified by a transmit precoding matrix indicator (TPMI) indicated in the DCI.

In one or more examples, the DCI may indicate multiple TCIs (i.e., multiple beams) for an uplink transmission (e.g., a multi-panel uplink transmission) and a single precoding matrix for the uplink transmission. However, an association between precoders of the single precoding matrix and the multiple TCIs may be unknown. For example, it may be unclear as to which precoders of the single precoding matrix are for generating a first beam indicated by the multiple TCIs, and which precoders of the single precoding matrix are for generating a second beam indicated by the multiple TCIs.

Some techniques and apparatuses described herein enable a UE to determine an association between multiple TCIs for an uplink transmission and precoders of a single precoding matrix for the uplink transmission. In some aspects, the UE may receive DCI that indicates first and second TCIs and a single precoding matrix. The single precoding matrix may include precoders for the first and second TCIs. However, the DCI may not identify the precoders that are for the first TCI and the precoders that are for the second TCI. In some aspects, the UE may determine that the first TCI is associated with a first set of antenna ports (e.g., port 0 and port 2) identified by the precoding matrix, and that the second TCI is associated with a second set of antenna ports (e.g., port 1 and port 3) identified by the precoding matrix. Thus, the UE may perform a multi-panel uplink transmission based at least in part on the associations of TCIs and sets of antenna ports. The use of a single precoding matrix for multiple TCIs improves signaling overhead and conserves network resources. In addition, the precoding matrix may be used to implicitly indicate a type of the uplink transmission (e.g., a dynamic panel selection transmission, a non-coherent joint transmission, or a joint transmission), which further improves signaling overhead and conserves network resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

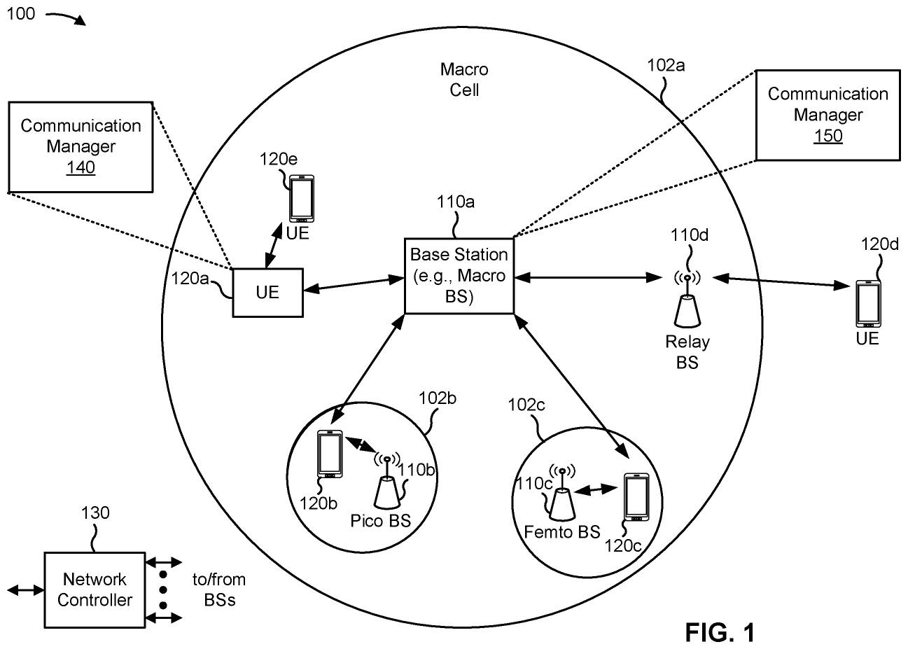

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul. UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In some aspects, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As shown in FIG. 1, the UE 120 may include a communication manager 140. As described in more detail elsewhere herein, the communication manager 140 may receive DCI that indicates a first TCI, a second TCI, and a precoding matrix, the first TCI being associated with a first set of antenna indices of the precoding matrix and the second TCI being associated with a second set of antenna indices of the precoding matrix, receive DCI that indicates a first beam and a second beam for a first set of antenna indices and a second set of antenna indices that identify sounding reference signal (SRS) antenna ports associated with multiple SRS resources of multiple SRS resource sets, transmit an uplink transmission based at least in part on the DCI, and/or the like. Additionally, or alternatively, the communication manager 140 may perform one or more other operations described herein.

In some aspects, the base station 110 may include a communication manager 150. As described in more detail elsewhere herein, the communication manager 150 may transmit DCI that indicates a first TCI, a second TCI, and a precoding matrix for a UE, the first TCI being associated with a first set of antenna indices of the precoding matrix and the second TCI being associated with a second set of antenna indices of the precoding matrix, transmit, to a UE, DCI that indicates a first beam and a second beam for a first set of antenna indices and a second set of antenna indices that identify SRS antenna ports associated with multiple SRS resources of multiple SRS resource sets, receive an uplink transmission from the UE based at least in part on the DCI, and/or the like. Additionally, or alternatively, the communication manager 150 may perform one or more other operations described herein.

As indicated above, FIG. 1 is provided merely as an example. Other examples may differ from what is described with regard to FIG. 1.

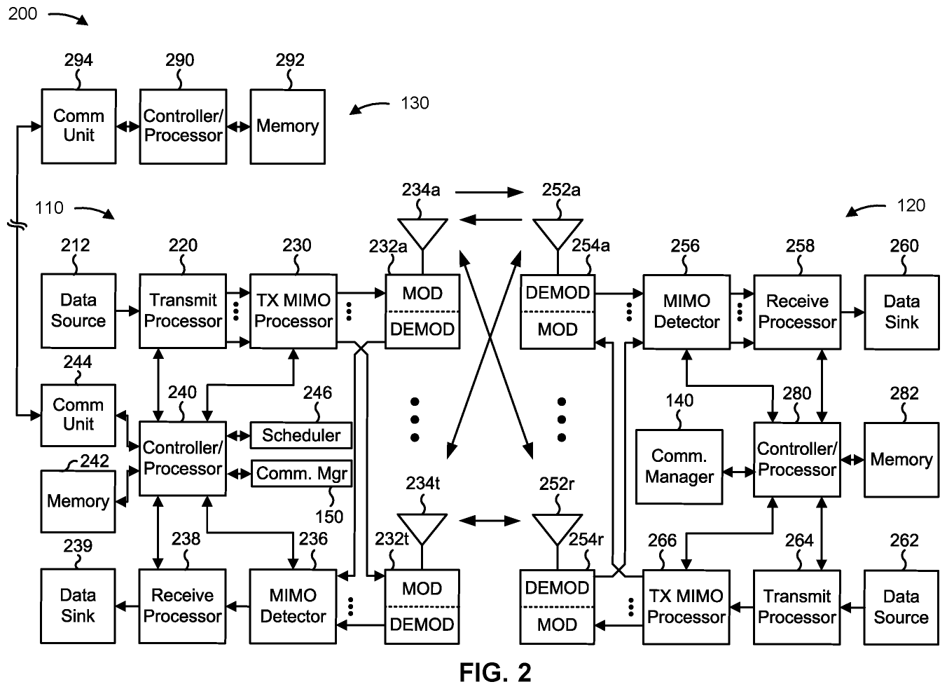

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports comprising RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein.

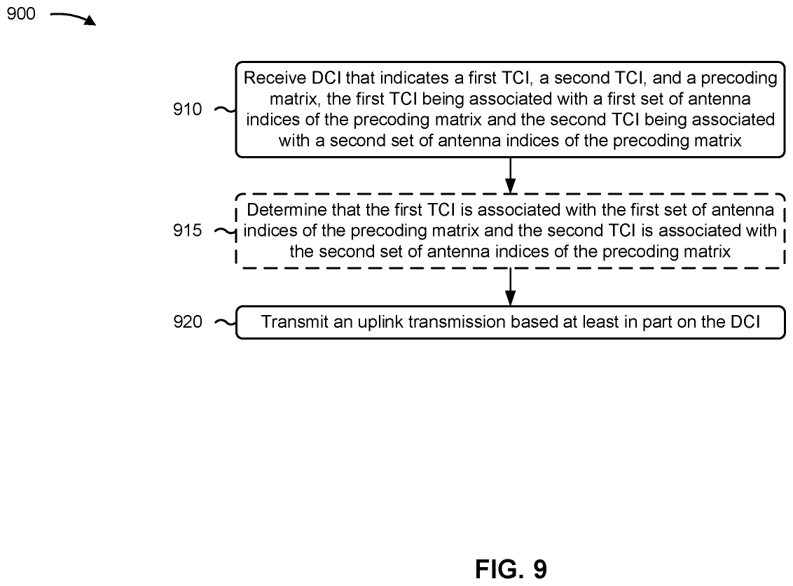

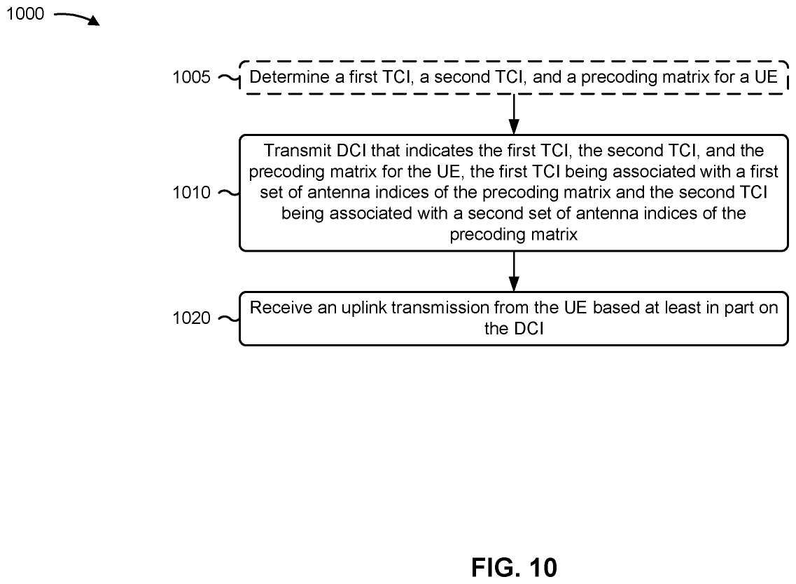

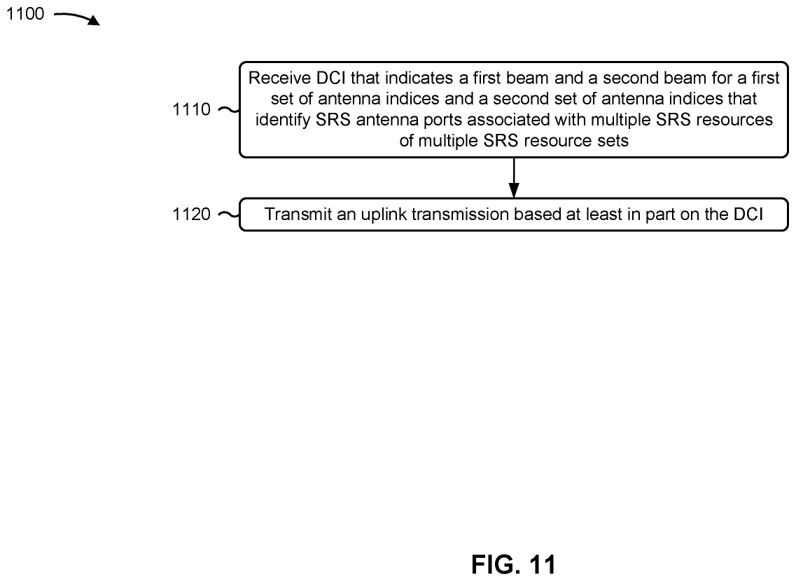

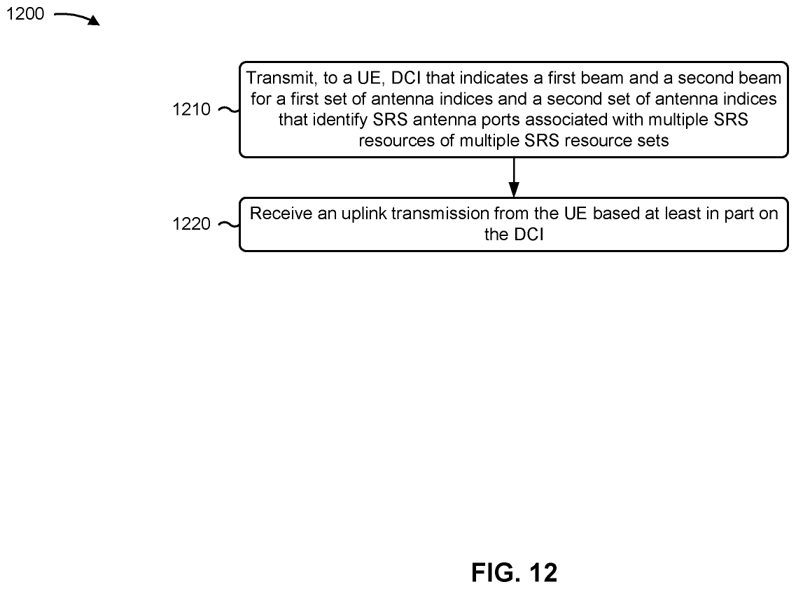

Controller/processor 240 of base station 110, controller/processor 280 of UE 120, and/or any other component(s) of FIG. 2 may perform one or more techniques related to association of TCIs and precoders in uplink transmissions, as described in more detail elsewhere herein. For example, controller/processor 240 of base station 110, controller/processor 280 of UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, process 1100 of FIG. 11, process 1200 of FIG. 12, and/or other processes as described herein. In some aspects, executing instructions may include running the instructions, converting the instructions, compiling the instructions, and/or interpreting the instructions, among other examples.

In some aspects, the UE 120 may include means for receiving DCI that indicates a first TCI, a second TCI, and a precoding matrix, the first TCI being associated with a first set of antenna indices of the precoding matrix and the second TCI being associated with a second set of antenna indices of the precoding matrix, means for receiving DCI that indicates a first beam and a second beam for a first set of antenna indices and a second set of antenna indices that identify SRS antenna ports associated with multiple SRS resources of multiple SRS resource sets, means for transmitting an uplink transmission based at least in part on the DCI, and/or the like. Additionally, or alternatively, the UE 120 may include means for performing one or more other operations described herein. In some aspects, such means may include the communication manager 140. Additionally, or alternatively, such means may include one or more components of the UE 120 described in connection with FIG. 2.

In some aspects, the base station 110 may include means for transmitting DCI that indicates a first TCI, a second TCI, and a precoding matrix for a UE, the first TCI being associated with a first set of antenna indices of the precoding matrix and the second TCI being associated with a second set of antenna indices of the precoding matrix, means for transmitting, to a UE, DCI that indicates a first beam and a second beam for a first set of antenna indices and a second set of antenna indices that identify SRS antenna ports associated with multiple SRS resources of multiple SRS resource sets, means for receiving an uplink transmission from the UE based at least in part on the DCI, and/or the like. Additionally, or alternatively, the base station 110 may include means for performing one or more other operations described herein. In some aspects, such means may include the communication manager 150. In some aspects, such means may include one or more components of the base station 110 described in connection with FIG. 2.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided merely as an example Other examples may differ from what is described with regard to FIG. 2.

In one or more examples, a UE may receive DCI that indicates two TCI states (e.g., in a codepoint of the DCI field for transmission configuration indication) and one or more DMRS ports within two code-division multiplexing (CDM) groups (e.g., in the DCI field for antenna ports). Here, a first of the two TCI states may correspond to the CDM group of a first antenna port indicated by an antenna port indication table, and a second of the two TCI states may correspond to the other CDM group.

In one or more examples, a UE may transmit an uplink transmission using a beam. The beam may be indicated by a TCI (e.g., a TCI state) in DCI received by the UE. The UE may generate the beam for transmitting the uplink transmission using a precoding matrix. The precoding matrix may be identified by a TPMI indicated in the DCI.

In one or more examples, the DCI may indicate multiple TCIs (i.e., multiple beams) for an uplink transmission (e.g., a multi-panel uplink transmission) and a single precoding matrix for the uplink transmission. However, an association between precoders of the single precoding matrix and the multiple TCIs may be unknown. For example, it may be unclear as to which precoders of the single precoding matrix are for generating a first beam indicated by the multiple TCIs, and which precoders of the single precoding matrix are for generating a second beam indicated by the multiple TCIs.

Some techniques and apparatuses described herein enable a UE to determine an association between multiple TCIs for an uplink transmission and precoders of a single precoding matrix for the uplink transmission. In some aspects, the UE may receive DCI that indicates first and second TCIs and a single precoding matrix. The single precoding matrix may include precoders for the first and second TCIs. However, the DCI may not identify the precoders that are for the first TCI and the precoders that are for the second TCI. In some aspects, the UE may determine that the first TCI is associated with a first set of antenna ports (e.g., port 0 and port 2) identified by the precoding matrix, and that the second TCI is associated with a second set of antenna ports (e.g., port 1 and port 3) identified by the precoding matrix. Thus, the UE may perform a multi-panel uplink transmission based at least in part on the associations of TCIs and sets of antenna ports. The use of a single precoding matrix for multiple TCIs improves signaling overhead and conserves network resources. In addition, the precoding matrix may be used to implicitly indicate a type of the uplink transmission (e.g., a dynamic panel selection transmission, a non-coherent joint transmission, or a joint transmission), which further improves signaling overhead and conserves network resources.

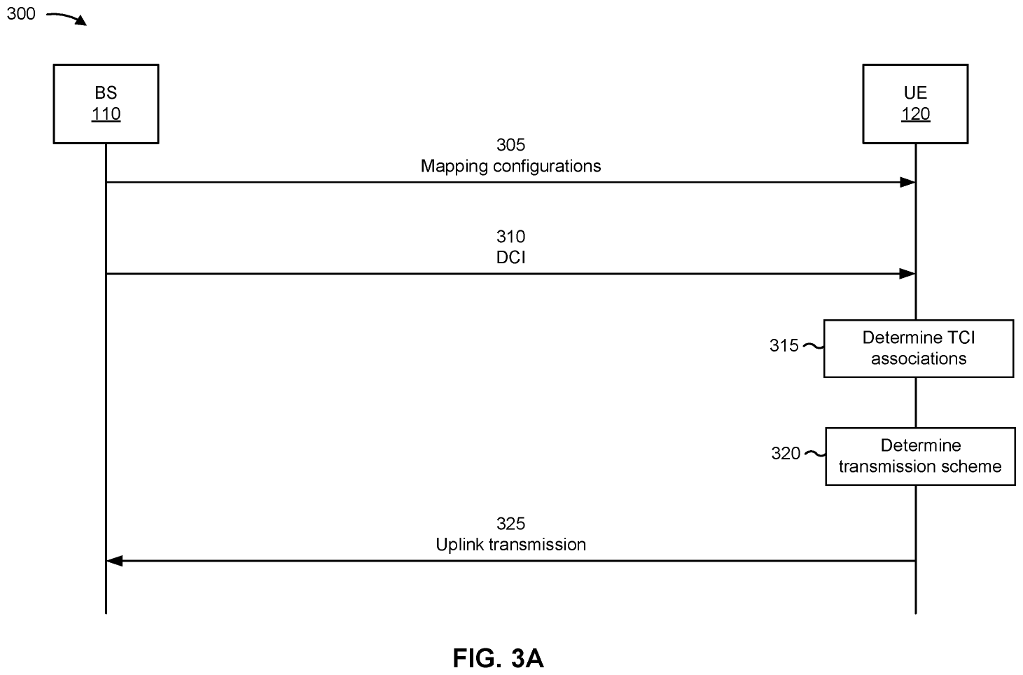

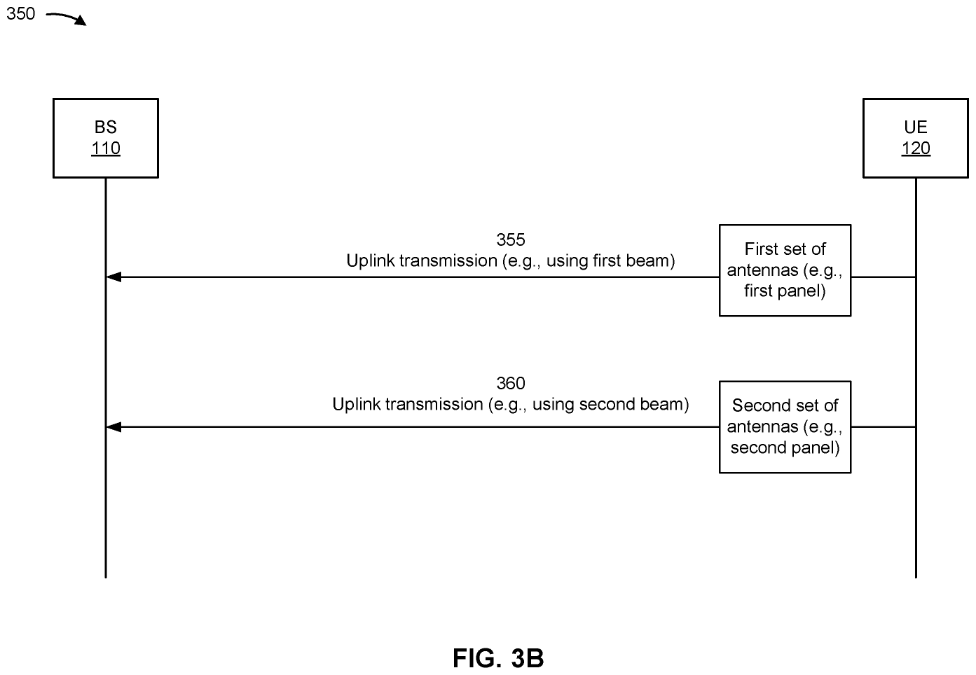

FIG. 3A is a diagram illustrating an example 300 of association of TCIs and precoders in uplink transmissions, in accordance with the present disclosure. As shown in FIG. 3A, a UE 120 and a BS 110 may communicate in connection with an uplink transmission. In some aspects, the uplink transmission may use multiple antenna panels of the UE 120 (e.g., the uplink transmission may be a simultaneous uplink transmission). For example, the uplink transmission may be a joint transmission (e.g., a multiple layer transmission in which each layer is transmitted using multiple antenna panels (i.e., multiple beams)) or a non-coherent joint transmission (e.g., a multiple layer transmission in which each layer is transmitted using a respective antenna panel (i.e., a respective beam)). In some aspects, the uplink transmission may be enabled for use of multiple antenna panels of the UE 120. For example, the uplink transmission may be a dynamic panel selection transmission (e.g., a multiple layer transmission in which each layer is transmitted using the same antenna panel (i.e., the same beam) that is dynamically selected).

As shown by reference number 305, the BS 110 may transmit, and the UE 120 may receive, one or more configurations for mappings that are to be used by the UE 120. In some aspects, the BS 110 may transmit a configuration for a mapping (e.g., mapping 442, 462, and/or 472, as described below) for DMRS ports. For example, the mapping may map index values to DMRS ports and CDM group indications. In some aspects, the BS 110 may transmit a configuration for a mapping for TPMIs. For example, the mapping may map index values to TPMIs.

As shown by reference number 310, the BS 110 may transmit, and the UE 120 may receive, DCI. The DCI may provide an uplink grant for an uplink transmission of the UE 120. In some aspects, the DCI may indicate a first TCI and a second TCI (e.g., in a codepoint of a TCI field of the DCI). The first TCI and the second TCI may identify respective beams (or antenna groups) for the uplink transmission of the UE 120. In some aspects, a TCI may identify a reference signal, such as a channel state information reference signal (CSI-RS), a synchronization signal block (SSB), an SRS, and/or the like, which is associated with a beam or a reception spatial filter providing spatial relation information or quasi-co-location (QCL) information. In some aspects, a TCI may identify a reference signal set, such as a CSI-RS resource set, an SRS resource set, and/or the like.

In some aspects, the DCI may indicate a precoding matrix. For example, the DCI may indicate a TPMI index that maps to (e.g., according to a mapping received by the UE 120) a TPMI associated with the precoding matrix. The precoding matrix may include precoders for antennas in multiple layers.

In some aspects, the DCI may indicate a set of DMRS antenna ports (e.g., in an antenna port(s) field of the DCI). For example, the DCI may indicate a DMRS antenna port index that maps to (e.g., according to a mapping received by the UE 120) the set of DMRS antenna ports. A DMRS antenna port may be associated with a particular CDM group. For example, one or more first DMRS antenna ports of the set may be associated with a first CDM group, and one or more second DMRS antenna ports of the set may be associated with a second CDM group.

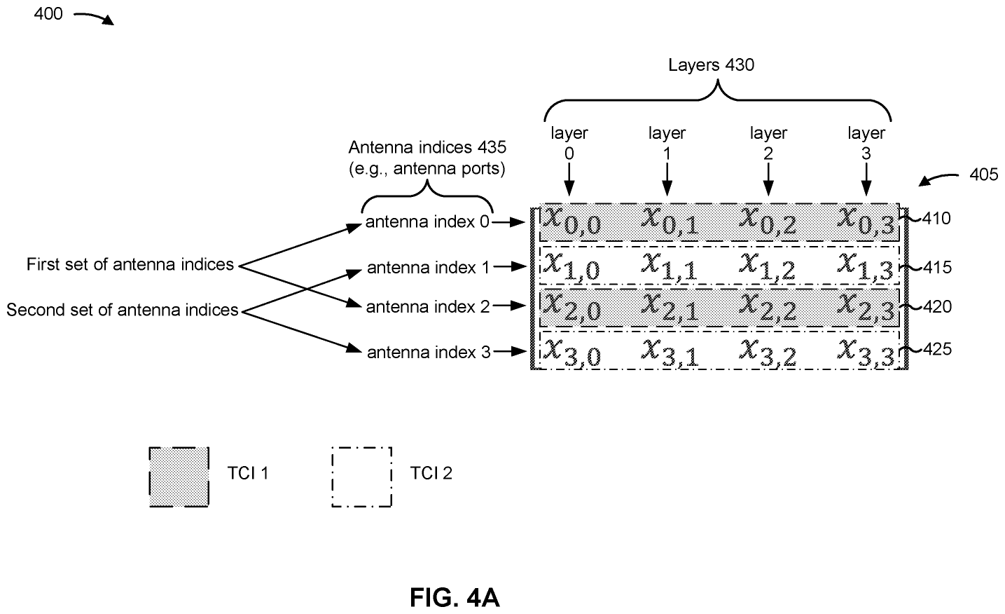

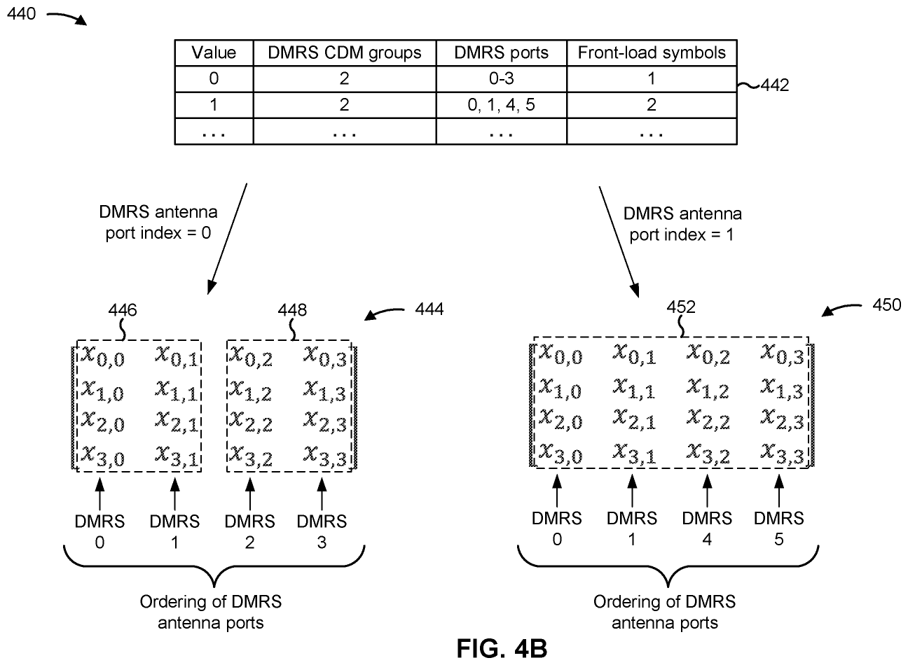

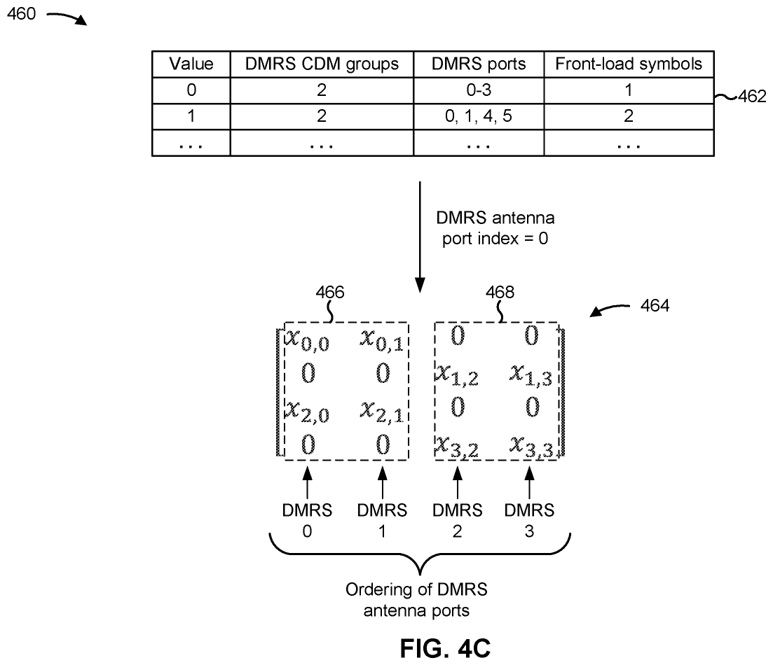

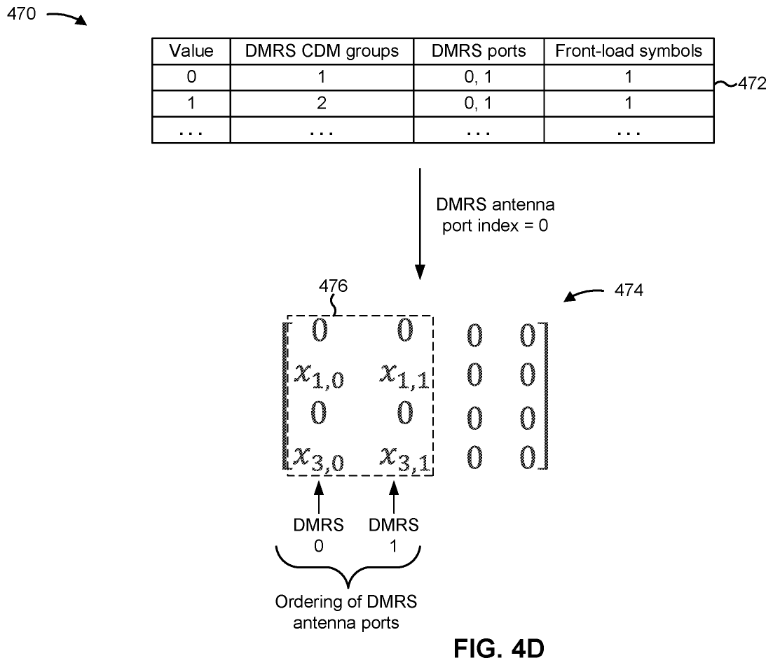

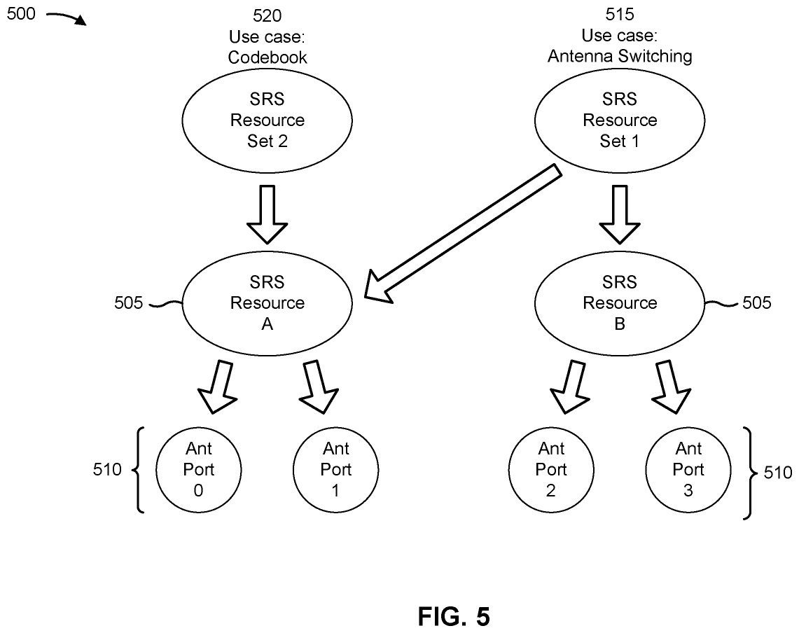

As shown by reference number 315, the UE 120 may determine associations between the TCIs indicated by the DCI and the precoders of the precoding matrix indicated by the DCI. For example, the UE 120 may determine that the first TCI is associated with a first set of antenna indices of the precoding matrix and that the second TCI is associated with a second set of antenna indices of the precoding matrix, as described in connection with FIG. 4A. As shown by reference number 320, the UE 120 may determine a transmission scheme associated with the DCI (e.g., whether the DCI is for a joint transmission, a non-coherent joint transmission, or a dynamic panel selection transmission) based at least in part on the precoding matrix and the associations that are determined, as described in connection with FIGS. 5-7.

As shown by reference number 325, the UE 120 may transmit, and the BS 110 may receive, an uplink transmission according to the associations and the transmission scheme that are determined. For example, the UE 120 may transmit a joint transmission using a first beam, according to precoders associated with the first TCI, and a second beam according to precoders associated with the second TCI. As another example, the UE 120 may transmit a non-coherent joint transmission using a first beam, according to precoders associated with the first TCI, and a second beam according to precoders associated with the second TCI. As a further example, the UE 120 may transmit the uplink transmission (e.g., a single-panel transmission) using a first beam, according to precoders associated with the first TCI, or a second beam according to precoders associated with the second TCI.

As indicated above, FIG. 3A is provided as an example Other examples may differ from what is described with respect to FIG. 3A.

FIG. 3B is a diagram illustrating an example 350 of a multi-panel uplink transmission, in accordance with the present disclosure.

As shown by reference number 355, the UE 120 may transmit, and the BS 110 may receive, an uplink transmission using a first beam (e.g., in accordance with a first TCI). The UE 120 may transmit the uplink transmission using a first antenna panel associated with a first set of antennas (e.g., antenna ports). As shown by reference number 360, the UE 120 may transmit, and the BS 110 may receive, an uplink transmission using a second beam (e.g., in accordance with a second TCI). The UE 120 may transmit the uplink transmission using a second antenna panel associated with a second set of antennas (e.g., antenna ports). In some aspects, the UE 120 may transmit the uplink transmissions to different antenna panels of the same BS 110 (as shown), or transmit the uplink transmission to antenna panels of different BSs 110. The multi-panel uplink transmissions may be a joint transmission (e.g., a coherent joint transmission) or a non-coherent joint transmission.

As indicated above, FIG. 3B is provided as an example. Other examples may differ from what is described with respect to FIG. 3B.

FIG. 4A is a diagram illustrating an example 400 of association of TCIs and precoders in uplink transmissions, in accordance with the present disclosure. As described in connection with FIG. 3A, the UE 120 may receive DCI that indicates a precoding matrix. FIG. 4A shows an example precoding matrix 405 that may be indicated by the DCI received by the UE 120.

As shown in FIG. 4A, the precoding matrix 405 may include precoders in multiple columns and multiple rows. A column may represent (e.g., may be mapped to) a layer 430 that is to be transmitted, and a row may represent (e.g., may be mapped to) an antenna index 435 (e.g., an antenna port). Accordingly, X_{0,0} of the precoding matrix 405 may represent a precoder for a first antenna (e.g., associated with antenna index 0) in a first layer 430 (e.g., layer 0), X_{1,0} of the precoding matrix 405 may represent a precoder for a second antenna (e.g., associated with antenna index 1) in the first layer 430 (e.g., layer 0), X_{0,1} of the precoding matrix 405 may represent a precoder for the first antenna (e.g., associated with antenna index 0) in a second layer 430 (e.g., layer 1), and so forth. In some aspects, the precoding matrix 405 may include a different quantity of columns (i.e., layers) and/or rows (i.e., antennas) than as shown in FIG. 4A.

In some aspects, an antenna index 435 may identify a physical uplink shared channel (PUSCH) antenna port (e.g., a TPMI antenna port) or an SRS antenna port. For example, an antenna index 435 of the precoding matrix 405 that identifies a PUSCH antenna port may also identify an SRS antenna port based at least in part on a one-to-one mapping between PUSCH antenna ports and SRS antenna ports. In some aspects, SRS antenna ports (e.g., associated with antenna indices 0-3) may be associated with a single SRS resource of an SRS resource set that has been configured for the UE 120 for codebook usage. In some aspects, the SRS antenna ports may be associated with multiple SRS resources of an SRS resource set that has been configured for the UE 120 for codebook usage. In some aspects, the SRS antenna ports may be associated with multiple SRS resources of multiple SRS resource sets that have been configured for the UE 120 for codebook usage.

As described in connection with FIG. 3A, the UE 120 may receive DCI that indicates a first TCI and a second TCI, and the UE 120 may determine associations between the TCIs and antenna indices 435. For example, as shown in FIG. 4A, the first TCI (TCI 1) may be associated with (e.g., bundled with) a first set of antenna indices (e.g., a first set of TPMI ports or SRS ports) of the precoding matrix 405, and the second TCI (TCI 2) may be associated with (e.g., bundled with) a second set of antenna indices (e.g., a second set of TPMI ports or SRS ports) of the precoding matrix 405. For example, the first TCI may be associated with the precoders 410 for a first antenna (associated with antenna index 0) and the precoders 420 for a third antenna (associated with antenna index 2) (e.g., the first antenna and the third antenna may be associated with a first antenna panel). Continuing with the previous example, the second TCI may be associated with the precoders 415 for a second antenna (associated with antenna index 1) and the precoders 425 for a fourth antenna (associated with antenna index 3) (e.g., the second antenna and the fourth antenna may be associated with a second antenna panel).

The UE 120 may determine associations of TCIs and antenna indices based at least in part on a configuration of the UE 120. For example, the configuration may indicate an association of the first TCI (TCI 1) with antenna indices 0 and 2 (i.e., even-numbered antenna indices), and an association of the second TCI (TCI 2) with antenna indices 1 and 3 (i.e., odd-numbered antenna indices), as shown in FIG. 4A. In some aspects, the configuration may indicate different associations from those shown in FIG. 4A. For example, the first TCI may be associated with odd-numbered antenna indices and the second TCI may be associated with even-numbered antenna indices, the first TCI may be associated with the two lowest-numbered antenna indices and the second TCI may be associated with the two highest-numbered antenna indices, or the like.

As indicated above, FIG. 4A is provided as an example Other examples may differ from what is described with respect to FIG. 4A.

FIG. 4B is a diagram illustrating an example 440 of association of TCIs and precoders in uplink transmissions, in accordance with the present disclosure. As described in connection with FIG. 3A, the UE 120 may receive DCI that indicates a set of DMRS antenna ports (e.g., according to a DMRS antenna port index). For example, as shown in FIG. 4B, the DCI may indicate a DMRS antenna port index value of 0 or the DCI may indicate a DMRS antenna port index value of 1. The DMRS antenna port index may identify the set of DMRS antenna ports according to a mapping 442 that is configured for the UE 120.

In some aspects, the set of antenna ports may be mapped (e.g., one-to-one) to layers of a precoding matrix, indicated by the DCI, according to an ordering of the set of DMRS antenna ports in the mapping 442. For example, according to the mapping 442, the set of DMRS antenna ports associated with the index value 0 may have an order of 0, 1, 2, 3 (shown in the mapping 442 by 0-3). In this example, a first layer (i.e., a first column) of a precoding matrix 444 may be mapped to DMRS antenna port 0 (DMRS 0), a second layer may be mapped to DMRS antenna port 1 (DMRS 1), a third layer may be mapped to DMRS antenna port 2 (DMRS 2), and a fourth layer may be mapped to DMRS antenna port 3 (DMRS 3). In other words, the first layer of the precoding matrix 444 may be transmitted by the UE 120 using DMRS antenna port 0, and so forth. Moreover, the set of DMRS antenna ports may be associated with one or more CDM groups. For example, as shown, DMRS antenna ports 0 and 1 may be a first CDM group 446, and DMRS antenna ports 2 and 3 may be a second CDM group 448.

As another example, according to the mapping 442, the set of DMRS antenna ports associated with the index value 1 may have an order of 0, 1, 4, 5. In this example, as shown, a first layer (i.e., a first column) of a precoding matrix 450 may be mapped to DMRS antenna port 0 (DMRS 0), a second layer may be mapped to DMRS antenna port 1 (DMRS 1), a third layer may be mapped to DMRS antenna port 4 (DMRS 4), and a fourth layer may be mapped to DMRS antenna port 5 (DMRS 5). Moreover, as shown, DMRS antenna ports 0, 1, 4, and 5 may be a single CDM group 452.

As described in connection with FIG. 3A, the UE 120 may determine a transmission scheme associated with the DCI based at least in part on a precoding matrix indicated by the DCI. In some aspects, the UE 120 may determine the transmission scheme according to the associations between TCIs and antenna indices described in connection with FIG. 4A. For example, as described in connection with FIG. 4A, a first set of antenna indices, associated with a first TCI, may include antenna index 0 and antenna index 2, and a second set of antenna indices, associated with a second TCI, may include antenna index 1 and antenna index 3.

In some aspects, the UE 120 may determine that a precoding matrix indicates a joint transmission based at least in part on a determination that a layer (e.g., any layer) of the precoding matrix includes precoders for one or more antenna indices of the first set of antenna indices and the second set of antenna indices. A precoder having a non-zero value may be considered to be included in a precoding matrix, and a precoder having a zero value may be considered not to be included in a precoding matrix. In some aspects, a non-zero value in a precoding matrix may also be referred to as a valid antenna (or a valid antenna port) or a non-zero antenna (or a non-zero antenna port).

As an example, as shown in FIG. 4B, the precoding matrix 444 indicates a joint transmission because each layer (i.e., column) of the precoding matrix 444 includes precoders for one or more antenna indices of the first set of antenna indices (e.g., antenna index 0 and antenna index 2) and the second set of antenna indices (e.g., antenna index 1 and antenna index 3), where an X (e.g., X_{0,0}) in the precoding matrix 444 indicates a non-zero value for a precoder. In this example, the first TCI (associated with the first set of antenna indices) and the second TCI (associated with the second set of antenna indices) may be associated with the CDM group 446 (e.g., CDM group 446 includes precoders associated with the first TCI and the second TCI), and the first TCI and the second TCI may be associated with CDM group 448. That is, the first TCI and the second TCI may be associated with the same CDM group.

As another example, as shown in FIG. 4B, the precoding matrix 450 indicates a joint transmission because each layer of the precoding matrix 450 includes precoders for one or more antenna indices of the first set of antenna indices and the second set of antenna indices. In this example, the first TCI (associated with the first set of antenna indices) and the second TCI (associated with the second set of antenna indices) may be associated with the CDM group 452.

In some aspects, the precoding matrix 444 or the precoding matrix 450 may correspond to Precoding Matrix 1:

$$\frac{1}{4} [ \begin{matrix}1 & 1 & 1 & 1 \\ 1 & - 1 & 1 & - 1 \\ j & j & - j & - j \\ j & - j & - j & j\end{matrix} ] \qquad Precoding Matrix 1$$

In Precoding Matrix 1, each layer (i.e., column) includes a precoder having a non-zero value for antenna indices 0 and 2 (the first set of antenna indices) and antenna indices 1 and 3 (the second set of antenna indices), thereby indicating a joint transmission.

In some aspects, the precoding matrix 444 or the precoding matrix 450 may have a different quantity of layers than shown in FIG. 4B. For example, the precoding matrix 444 or the precoding matrix 450 may have three layers and may correspond to Precoding Matrix 2, or may have two layers and may correspond to Precoding Matrix 3:

$$\frac{1}{2 \sqrt{3}} [ \begin{matrix}1 & 1 & 1 \\ 1 & - 1 & 1 \\ j & j & - j \\ j & - j & - j\end{matrix} ] \qquad Precoding Matrix 2$$

$$\frac{1}{2 \sqrt{2}} [ \begin{matrix}1 & 1 \\ j & j \\ 1 & - 1 \\ j & - j\end{matrix} ] \qquad Precoding Matrix 3$$

As indicated above, FIG. 4B is provided as an example. Other examples may differ from what is described with respect to FIG. 4B.

FIG. 4C is a diagram illustrating an example 460 of association of TCIs and precoders in uplink transmissions, in accordance with the present disclosure. As shown in FIG. 4C, DCI received by the UE 120 (described in connection with FIG. 3A) may indicate a DMRS antenna port index value of 0. The DMRS antenna port index may identify the set of DMRS antenna ports according to a mapping 462 that is configured for the UE 120.

The set of antenna ports may be mapped (e.g., one-to-one) to layers of a precoding matrix 464, indicated by the DCI, according to an ordering of the set of DMRS antenna ports in the mapping 462, as described in connection with FIG. 4B. For example, according to the mapping 462, the set of DMRS antenna ports associated with the index value 0 may have an order of 0, 1, 2, 3 (shown in the mapping 462 by 0-3), and the set of DMRS antenna ports may be mapped to the layers (i.e., columns) of the precoding matrix 464 in this order, as described in connection with FIG. 4B. Moreover, as shown, DMRS antenna ports 0 and 1 (DMRS 0 and DMRS 1) may be a first CDM group 466, and DMRS antenna ports 2 and 3 (DMRS 2 and DMRS 3) may be a second CDM group 468.

The UE 120 may determine a transmission scheme associated with the DCI based at least in part on a precoding matrix indicated by the DCI, as described in connection with FIG. 4B. For example, the UE 120 may determine the transmission scheme according to the associations between TCIs and antenna indices described in connection with FIG. 4A (e.g., a first set of antenna indices, associated with a first TCI, may include antenna index 0 and antenna index 2, and a second set of antenna indices, associated with a second TCI, may include antenna index 1 and antenna index 3).

In some aspects, the UE 120 may determine that a precoding matrix indicates a non-coherent joint transmission based at least in part on a determination that a first layer of the precoding matrix includes precoders for one or more antenna indices of the first set of antenna indices and does not include precoders for one or more antenna indices of the second set of antenna indices, and a second layer of the precoding matrix includes precoders for one or more antenna indices of the second set of antenna indices and does not include precoders for one or more antenna indices of the first set of antenna indices. In other words, the precoding matrix may indicate a non-coherent joint transmission when a layer (e.g., any layer) of the precoding matrix includes precoders for one or more antenna indices of only one of the first set of antenna indices or the second set of antenna indices, and at least one layer includes precoders for the first set of antenna indices and at least one layer includes precoders for the second set of antenna indices.

As an example, as shown in FIG. 4C, the precoding matrix 464 indicates a non-coherent joint transmission because at least one layer of the precoding matrix 464 (e.g., the layers associated with DMRS 0 and DMRS 1) includes precoders for one or more antenna indices of the first set of antenna indices (e.g., antenna index 0 and antenna index 2), and at least one layer of the precoding matrix 464 (e.g., the layers associated with DMRS 2 and DMRS 3) includes precoders for one or more antenna indices of the second set of antenna indices (e.g., antenna index 1 and antenna index 3), where an X (e.g., X_{0,0}) in the precoding matrix 464 indicates a non-zero value for a precoder (indicating that the precoder is included in the precoding matrix 464). In this example, the first TCI (associated with the first set of antenna indices) may be associated with the CDM group 466 (e.g., the CDM group associated with a smallest group identifier, such as CDM group 0), and the second TCI (associated with the second set of antenna indices) may be associated with the CDM group 468 (e.g., the CDM group associated with a largest group identifier, such as CDM group 1). That is, the first TCI and the second TCI may be associated with different CDM groups.

In some aspects, the precoding matrix 464 may correspond to Precoding Matrix 4:

$$\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ] \qquad Precoding Matrix 4$$

In Precoding Matrix 4, the first and second layers (i.e., the first and second columns) include precoders having non-zero values for only antenna indices 0 and 2 (the first set of antenna indices), and the third and fourth layers include precoders having non-zero values for only antenna indices 1 and 3 (the second set of antenna indices), thereby indicating a non-coherent joint transmission.

In some aspects, the precoding matrix 464 may have a different quantity of layers than shown in FIG. 4C. For example, the precoding matrix 464 may have three layers and may correspond to Precoding Matrix 5, or may have two layers and may correspond to Precoding Matrix 6:

$$\frac{1}{2} [ \begin{matrix}1 & 0 & 0 \\ 0 & 1 & 0 \\ - 1 & 0 & 0 \\ 0 & 0 & 1\end{matrix} ] \qquad Precoding Matrix 5$$

$$\frac{1}{2} [ \begin{matrix}1 & 0 \\ 0 & 1 \\ - j & 0 \\ 0 & 1\end{matrix} ] \qquad Precoding Matrix 6$$

As indicated above, FIG. 4C is provided as an example. Other examples may differ from what is described with respect to FIG. 4C.

FIG. 4D is a diagram illustrating an example 470 of association of TCIs and precoders in uplink transmissions, in accordance with the present disclosure. As shown in FIG. 4D, DCI received by the UE 120 (described in connection with FIG. 3A) may indicate a DMRS antenna port index value of 0. The DMRS antenna port index may identify the set of DMRS antenna ports according to a mapping 472 that is configured for the UE 120.

The set of antenna ports may be mapped (e.g., one-to-one) to layers of a precoding matrix 474, indicated by the DCI, according to an ordering of the set of DMRS antenna ports in the mapping 472, as described in connection with FIG. 4B. For example, according to the mapping 472, the set of DMRS antenna ports associated with the index value 0 may have an order of 0, 1, and the set of DMRS antenna ports may be mapped to the layers (i.e., columns) of the precoding matrix 474 in this order, as described in connection with FIG. 4B. Moreover, as shown, DMRS antenna ports 0 and 1 (DMRS 0 and DMRS 1) may be a CDM group 476.

The UE 120 may determine a transmission scheme associated with the DCI based at least in part on a precoding matrix indicated by the DCI, as described in connection with FIG. 4B. For example, the UE 120 may determine the transmission scheme according to the associations between TCIs and antenna indices described in connection with FIG. 4A (e.g., a first set of antenna indices, associated with a first TCI, may include antenna index 0 and antenna index 2, and a second set of antenna indices, associated with a second TCI, may include antenna index 1 and antenna index 3).

In some aspects, the UE 120 may determine that a precoding matrix indicates a dynamic panel selection transmission (e.g., a non-coherent transmission) based at least in part on a determination that all layers of the precoding matrix include precoders for one or more antenna indices of one of the first set of antenna indices or the second set of antenna indices, and do not include precoders for one or more antenna indices of the other of the first set of antenna indices or the second set of antenna indices. In other words, the precoding matrix may indicate a dynamic panel selection transmission when the layers of the precoding matrix include precoders for one or more antenna indices of only one of the first set of antenna indices or the second set of antenna indices.

As an example, as shown in FIG. 4D, the precoding matrix 474 indicates a dynamic panel selection transmission because each layer (i.e., each layer mapped to a DMRS antenna port) of the precoding matrix 474 (e.g., the layers associated with DMRS 0 and DMRS 1) includes precoders for one or more antenna indices of only the second set of antenna indices (e.g., antenna index 1 and antenna index 3), where an X (e.g., X_{1,0}) in the precoding matrix 474 indicates a non-zero value for a precoder (indicating that the precoder is included in the precoding matrix 474). In this example, the first TCI (associated with the first set of antenna indices) may not be associated with a CDM group, and the second TCI (associated with the second set of antenna indices) may be associated with the CDM group 476 (thereby indicating that the dynamic panel selection transmission is to use a beam identified by the second TCI). That is, only one of the first TCI or the second TCI is associated with a CDM group.

In some aspects, the precoding matrix 474 may correspond to Precoding Matrix 7:

$$\frac{1}{2} [ \begin{matrix}0 & 0 \\ 1 & 0 \\ 0 & 0 \\ 0 & 1\end{matrix} ] \qquad Precoding Matrix 7$$

In Precoding Matrix 7, the first layer (i.e., the first column) includes a precoder having a non-zero value for antenna index 1 (in the second set of antenna indices) and the second layer includes a precoder having a non-zero value for antenna index 3 (in the second set of antenna indices), and precoders for the first set of antenna indices are not included in any layer, thereby indicating a dynamic panel selection.

As indicated above, FIG. 4D is provided as an example. Other examples may differ from what is described with respect to FIG. 4D.

FIG. 5 is a diagram illustrating an example 500 of SRS resource sets, in accordance with the present disclosure.

A base station 110 may configure a UE 120 with one or more SRS resource sets to allocate resources for SRS transmissions by the UE 120. For example, a configuration for SRS resource sets may be indicated in a radio resource control (RRC) message (e.g., an RRC configuration message or an RRC reconfiguration message). As shown by reference number 505, an SRS resource set may include one or more resources (e.g., shown as SRS resources), which may include time resources and/or frequency resources (e.g., a slot, a symbol, a resource block, and/or a periodicity for the time resources).

As shown by reference number 510, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a base station 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a base station 110 indicates an uplink precoder to the UE 120. For example, when the base station 110 is configured to indicate an uplink precoder to the UE 120 (e.g., using a precoder codebook), the base station 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the base station 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the base station 110 indicating an uplink precoder to be used by the UE 120. For example, when the UE 120 is configured to select an uplink precoder, the base station 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the base station 110).

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X≤4). In some aspects, each of the X SRS ports may mapped to a corresponding symbol of the SRS resource and used for transmission of an SRS in that symbol.

As shown in FIG. 5, in some aspects, different SRS resource sets indicated to the UE 120 (e.g., having different use cases) may overlap (e.g., in time and/or in frequency, such as in the same slot). For example, as shown by reference number 515, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 520, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

As indicated above, FIG. 5 is provided as an example. Other examples may differ from what is described with regard to FIG. 5.

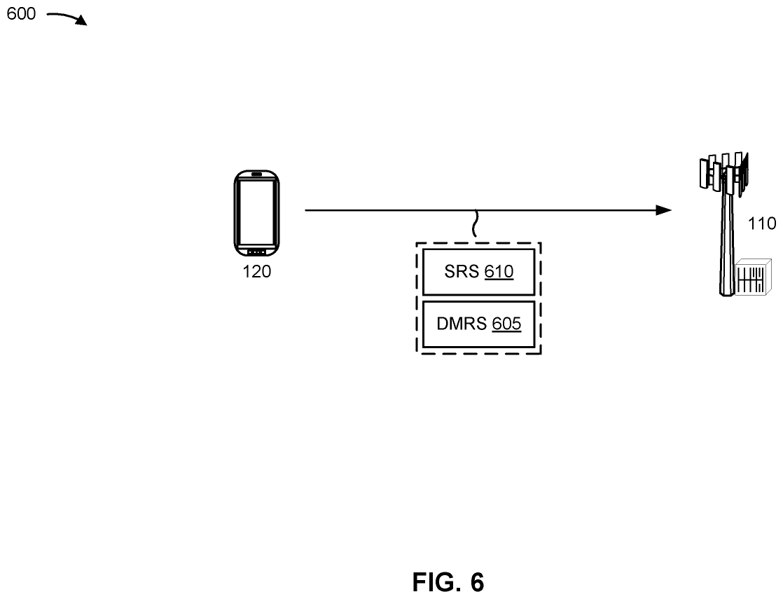

FIG. 6 is a diagram illustrating an example 600 of reference signals in a wireless network, in accordance with the present disclosure. As shown in FIG. 6, uplink reference signals may carry information from a UE 120 to a base station 110.

A DMRS 605 may carry information used to estimate a radio channel for demodulation of an associated physical channel (e.g., a PUSCH). The design and mapping of the DMRS 605 may be specific to a physical channel for which the DMRS 605 is used for estimation. The DMRS 605 can be UE-specific, can be beamformed, can be confined in a scheduled resource (e.g., rather than transmitted on a wideband), and can be transmitted only when necessary.

An SRS 610 may carry information used for uplink channel estimation, which may be used for scheduling, link adaptation, precoder selection, or beam management, among other examples. The base station 110 may configure one or more SRS resource sets for the UE 120, as described above, and the UE 120 may transmit SRSs 610 on the configured SRS resource sets. An SRS resource set may have a configured usage, such as uplink CSI acquisition, downlink CSI acquisition for reciprocity-based operations, uplink beam management, among other examples, as described above. The base station 110 may measure the SRSs 610, may perform channel estimation based at least in part on the measurements, and may use the SRS measurements to configure communications with the UE 120.

As indicated above, FIG. 6 is provided as an example. Other examples may differ from what is described with regard to FIG. 6.

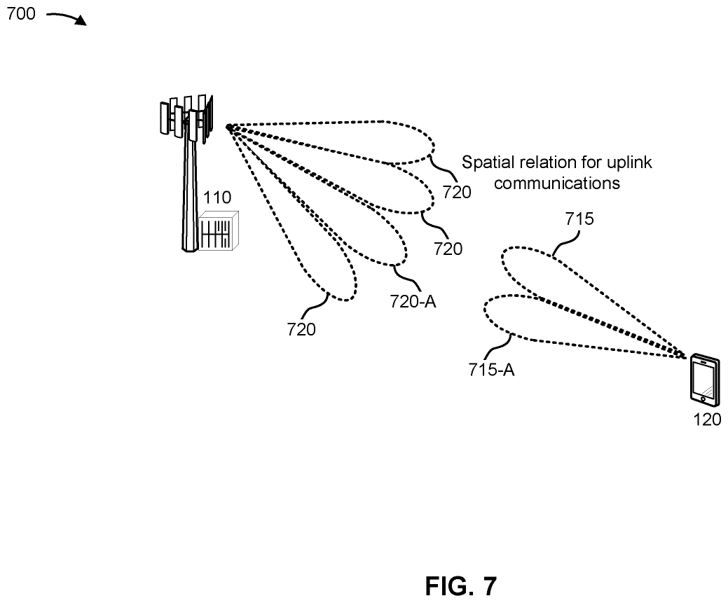

FIG. 7 is a diagram illustrating an example 700 of using beams for communications between a base station and a UE, in accordance with the present disclosure. As shown in FIG. 7, a base station 110 and a UE 120 may communicate with one another.

The UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 715.

The base station 110 may receive uplink transmissions via one or more BS receive beams 720. The base station 110 may identify a particular UE transmit beam 715, shown as UE transmit beam 715-A, and a particular BS receive beam 720, shown as BS receive beam 720-A, that provide relatively favorable performance (for example, that have a best channel quality of the different measured combinations of UE transmit beams 715 and BS receive beams 720). In some examples, the base station 110 may transmit an indication of which UE transmit beam 715 is identified by the base station 110 as a preferred UE transmit beam, which the base station 110 may select for transmissions from the UE 120. The UE 120 and the base station 110 may thus attain and maintain a beam pair link for uplink communications (for example, a combination of the UE transmit beam 715-A and the BS receive beam 720-A), which may be further refined and maintained in accordance with one or more established beam refinement procedures. An uplink beam, such as a UE transmit beam 715 or a BS receive beam 720, may be associated with a spatial relation. A spatial relation may indicate a directionality or a characteristic of the uplink beam. In some examples, an uplink beam may be indicated by an uplink TCI state.

As indicated above, FIG. 7 is provided as an example. Other examples may differ from what is described with respect to FIG. 7.

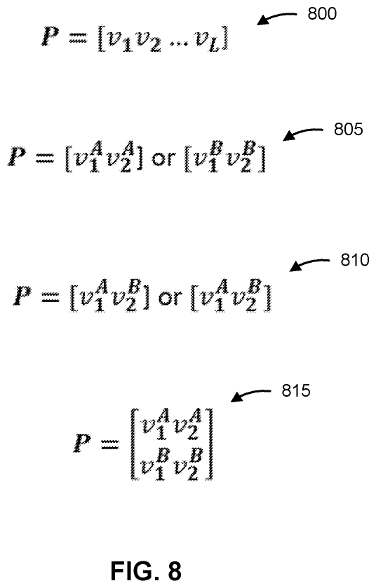

FIG. 8 is a diagram illustrating one or more examples of precoder matrices, in accordance with the present disclosure. In some aspects, a UE may be configured or otherwise provisioned with one or more precoder matrices. A precoder matrix that the UE is to use for an uplink transmission may be indicated to a UE (e.g., in DCI) by a TPMI, as described above.

Example 800 shows a precoder matrix (P) for single panel transmission using multiple transmission layers. In example 800, v₁ represents a precoder for a first layer, v₂ represents a precoder for a second layer, and v_{L} represents a precoder for a layer L.

Example 805 shows precoder matrices (P) for a transmission using dynamic panel selection. In example 805, v₁^{A} represents a precoder for a first layer for a first antenna panel (A), v₂^{A} represents a precoder for a second layer for the first antenna panel (A), v₁^{B} represents a precoder for a first layer for a second antenna panel (B), and v₂^{B} represents a precoder for a second layer for the second antenna panel (B). Accordingly, a transmission using dynamic panel selection may be a multiple layer transmission in which each layer is transmitted using the same antenna panel that is dynamically selected (e.g., in DCI). The antenna panel may include a group of antenna ports, and may be identified by an explicit panel identifier or an implicit resource identifier, such as a reference signal identifier, a TCI, or the like.

Example 810 shows precoder matrices (P) for a non-coherent joint transmission (e.g., a transmission using spatial division multiplexing (SDM)). In example 810, v₁^{A} represents a precoder for a first layer for a first antenna panel (A), and v₂^{B} represents a precoder for a second layer for a second antenna panel (B). Accordingly, a non-coherent joint transmission may be a multiple layer transmission in which each layer is transmitted using a respective antenna panel.

Example 815 shows a precoder matrix (P) for joint transmission (e.g., an aggregated panel transmission). In example 815, v₁^{A} represents a precoder for a first layer for a first antenna panel (A), v₂^{A} represents a precoder for a second layer for the first antenna panel (A), v₁^{B} represents a precoder for the first layer for a second antenna panel (B), and v₂^{B} represents a precoder for the second layer for the second antenna panel (B). Accordingly, a joint transmission may be a multiple layer transmission in which each layer is transmitted using multiple antenna panels.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with association of TCIs and precoders in uplink transmissions.

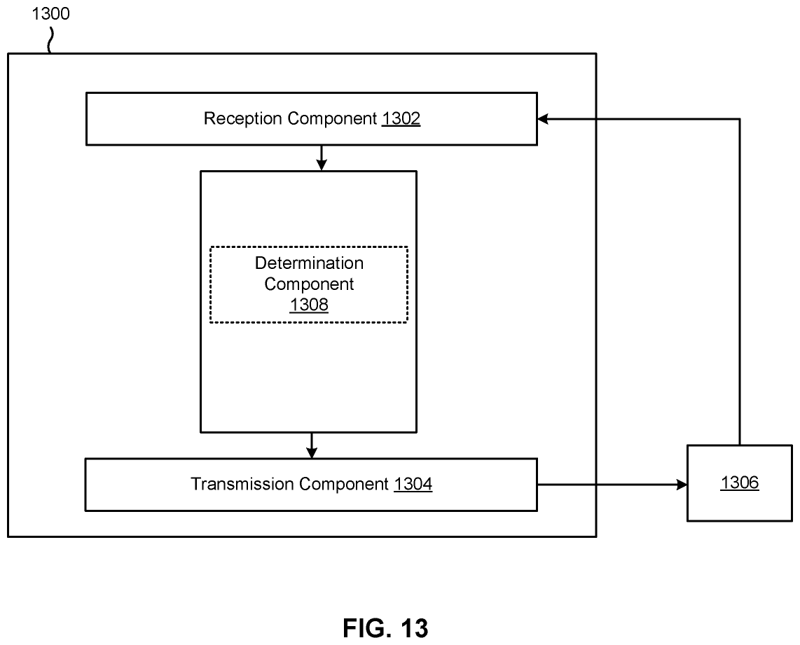

As shown in FIG. 9, in some aspects, process 900 may include receiving DCI that indicates a first TCI, a second TCI, and a precoding matrix, the first TCI being associated with a first set of antenna indices of the precoding matrix and the second TCI being associated with a second set of antenna indices of the precoding matrix (block 910). For example, the UE (e.g., using reception component 1302, depicted in FIG. 13) may receive DCI that indicates a first TCI, a second TCI, and a precoding matrix, the first TCI being associated with a first set of antenna indices of the precoding matrix and the second TCI being associated with a second set of antenna indices of the precoding matrix, as described above.

In some aspects, process 900 may include determining that the first TCI is associated with the first set of antenna indices of the precoding matrix and the second TCI is associated with the second set of antenna indices of the precoding matrix (block 915). For example, the UE (e.g., using determination component 1308, depicted in FIG. 13) may determine that the first TCI is associated with the first set of antenna indices of the precoding matrix and the second TCI is associated with the second set of antenna indices of the precoding matrix, as described above.

As further shown in FIG. 9, in some aspects, process 900 may include transmitting an uplink transmission based at least in part on the DCI (block 920). For example, the UE (e.g., using transmission component 1304, depicted in FIG. 13) may transmit an uplink transmission based at least in part on the DCI, as described above.

Process 900 may include additional aspects, such as any single aspect or any combination of aspects described below and/or in connection with one or more other processes described elsewhere herein.

In a first aspect, the first set of antenna indices and the second set of antenna indices identify PUSCH antenna ports or SRS antenna ports.

In a second aspect, alone or in combination with the first aspect, the SRS antenna ports are associated with a single SRS resource of an SRS resource set, multiple SRS resources of a single SRS resource set, or multiple SRS resources of multiple SRS resource sets.

In a third aspect, alone or in combination with one or more of the first and second aspects, the DCI further indicates a set of DMRS antenna ports.

In a fourth aspect, alone or in combination with one or more of the first through third aspects, layers of the precoding matrix are mapped to the set of DMRS antenna ports according to an ordering of the set of DMRS antenna ports.

In a fifth aspect, alone or in combination with one or more of the first through fourth aspects, the precoding matrix indicates that the DCI is for a joint transmission based at least in part on a layer of the precoding matrix including a precoder for one or more antenna indices of the first set of antenna indices and one or more antenna indices of the second set of antenna indices.

In a sixth aspect, alone or in combination with one or more of the first through fifth aspects, the first TCI and the second TCI are associated with a same CDM group.

In a seventh aspect, alone or in combination with one or more of the first through sixth aspects, the precoding matrix indicates that the DCI is for a non-coherent joint transmission based at least in part on a first layer of the precoding matrix including a precoder for one or more antenna indices of the first set of antenna indices and not including a precoder for one or more antenna indices of the second set of antenna indices, and a second layer of the precoding matrix including a precoder for one or more antenna indices of the second set of antenna indices and not including a precoder for one or more antenna indices of the first set of antenna indices.

In an eighth aspect, alone or in combination with one or more of the first through seventh aspects, the first TCI is associated with a first CDM group, and the second TCI is associated with a second CDM group.

In a ninth aspect, alone or in combination with one or more of the first through eighth aspects, the precoding matrix indicates that the DCI is for a dynamic panel selection based at least in part on all layers of the precoding matrix including a precoder for one or more antenna indices of one of the first set of antenna indices or the second set of antenna indices, and not including a precoder for one or more antenna indices of the other of the first set of antenna indices or the second set of antenna indices.

In a tenth aspect, alone or in combination with one or more of the first through ninth aspects, the first TCI or the second TCI is associated with a CDM group.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with association of TCIs and precoders in uplink transmissions.

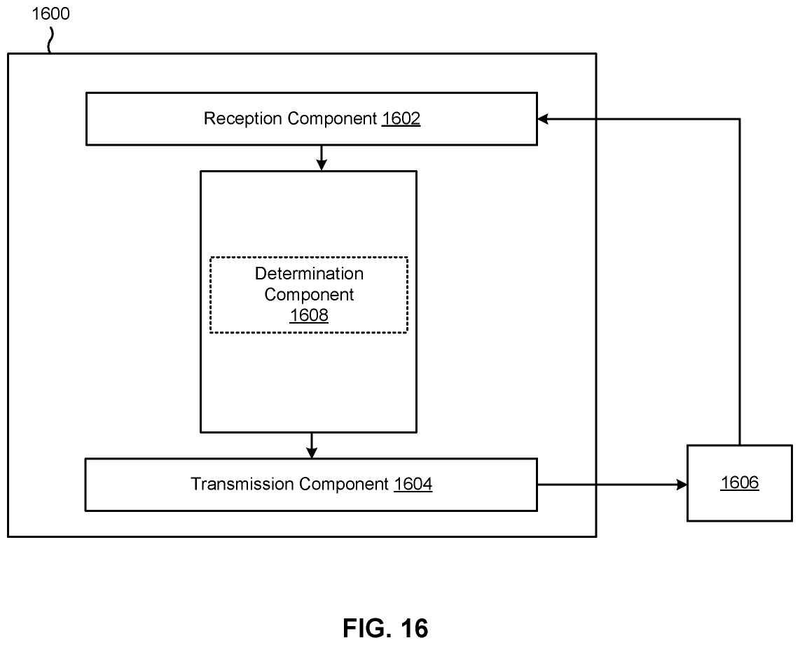

In some aspects, process 1000 may include determining a first TCI, a second TCI, and a precoding matrix for a UE (block 1005). For example, the base station (e.g., using determination component 1608, depicted in FIG. 16) may determine a first TCI, a second TCI, and a precoding matrix for a UE, as described above.

As shown in FIG. 10, in some aspects, process 1000 may include transmitting DCI that indicates the first TCI, the second TCI, and the precoding matrix for the UE, the first TCI being associated with a first set of antenna indices of the precoding matrix and the second TCI being associated with a second set of antenna indices of the precoding matrix (block 1010). For example, the base station (e.g., using transmission component 1604, depicted in FIG. 16) may transmit DCI that indicates the first TCI, the second TCI, and the precoding matrix for the UE, the first TCI being associated with a first set of antenna indices of the precoding matrix and the second TCI being associated with a second set of antenna indices of the precoding matrix, as described above.

As further shown in FIG. 10, in some aspects, process 1000 may include receiving an uplink transmission from the UE based at least in part on the DCI (block 1020). For example, the base station (e.g., using reception component 1602, depicted in FIG. 16) may receive an uplink transmission from the UE based at least in part on the DCI, as described above.

Process 1000 may include additional aspects, such as any single aspect or any combination of aspects described below and/or in connection with one or more other processes described elsewhere herein.

In a first aspect, the first set of antenna indices and the second set of antenna indices identify PUSCH antenna ports or SRS antenna ports.

In a second aspect, alone or in combination with the first aspect, the SRS antenna ports are associated with a single SRS resource of an SRS resource set, multiple SRS resources of a single SRS resource set, or multiple SRS resources of multiple SRS resource sets.

In a third aspect, alone or in combination with one or more of the first and second aspects, the DCI further indicates a set of DMRS antenna ports.

In a fourth aspect, alone or in combination with one or more of the first through third aspects, layers of the precoding matrix are mapped to the set of DMRS antenna ports according to an ordering of the set of DMRS antenna ports.

In a fifth aspect, alone or in combination with one or more of the first through fourth aspects, the precoding matrix indicates that the DCI is for a joint transmission based at least in part on a layer of the precoding matrix including a precoder for one or more antenna indices of the first set of antenna indices and one or more antenna indices of the second set of antenna indices.

In a sixth aspect, alone or in combination with one or more of the first through fifth aspects, the first TCI and the second TCI are associated with a same CDM group.

In a seventh aspect, alone or in combination with one or more of the first through sixth aspects, the precoding matrix indicates that the DCI is for a non-coherent joint transmission based at least in part on a first layer of the precoding matrix including a precoder for one or more antenna indices of the first set of antenna indices and not including a precoder for one or more antenna indices of the second set of antenna indices, and a second layer of the precoding matrix including a precoder for one or more antenna indices of the second set of antenna indices and not including a precoder for one or more antenna indices of the first set of antenna indices.

In an eighth aspect, alone or in combination with one or more of the first through seventh aspects, the first TCI is associated with a first CDM group, and the second TCI is associated with a second CDM group.

In a ninth aspect, alone or in combination with one or more of the first through eighth aspects, the precoding matrix indicates that the DCI is for a dynamic panel selection based at least in part on all layers of the precoding matrix including a precoder for one or more antenna indices of one of the first set of antenna indices or the second set of antenna indices, and not including a precoder for one or more antenna indices of the other of the first set of antenna indices or the second set of antenna indices.

In a tenth aspect, alone or in combination with one or more of the first through ninth aspects, the first TCI or the second TCI is associated with a CDM group.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with use of multiple SRS resource sets.

As shown in FIG. 11, in some aspects, process 1100 may include receiving DCI that indicates a first beam and a second beam for a first set of antenna indices and a second set of antenna indices that identify sounding reference signal (SRS) antenna ports associated with multiple SRS resources of multiple SRS resource sets (block 1110). For example, the UE (e.g., using reception component 1302, depicted in FIG. 13) may receive DCI that indicates a first beam and a second beam for a first set of antenna indices and a second set of antenna indices that identify sounding reference signal (SRS) antenna ports associated with multiple SRS resources of multiple SRS resource sets, as described above.

As further shown in FIG. 11, in some aspects, process 1100 may include transmitting an uplink transmission based at least in part on the DCI (block 1120). For example, the UE (e.g., using transmission component 1304, depicted in FIG. 13) may transmit an uplink transmission based at least in part on the DCI, as described above.

Process 1100 may include additional aspects, such as any single aspect or any combination of aspects described below and/or in connection with one or more other processes described elsewhere herein.

In a first aspect, the first set of antenna indices and the second set of antenna indices identify PUSCH antenna ports, and the PUSCH antenna ports identify the SRS antenna ports according to a mapping of PUSCH antenna ports to SRS antenna ports.

In a second aspect, alone or in combination with the first aspect, the uplink transmission is transmitted using the first beam and the second beam.

In a third aspect, alone or in combination with one or more of the first and second aspects, the uplink transmission is a multi-panel uplink transmission.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110) performs operations associated with use of multiple SRS resource sets.

As shown in FIG. 12, in some aspects, process 1200 may include transmitting, to a UE, DCI that indicates a first beam and a second beam for a first set of antenna indices and a second set of antenna indices that identify SRS antenna ports associated with multiple SRS resources of multiple SRS resource sets (block 1210). For example, the base station (e.g., using transmission component 1604, depicted in FIG. 16) may transmit, to a UE, DCI that indicates a first beam and a second beam for a first set of antenna indices and a second set of antenna indices that identify SRS antenna ports associated with multiple SRS resources of multiple SRS resource sets, as described above.

As further shown in FIG. 12, in some aspects, process 1200 may include receiving an uplink transmission from the UE based at least in part on the DCI (block 1220). For example, the base station (e.g., using reception component 1602, depicted in FIG. 16) may receive an uplink transmission from the UE based at least in part on the DCI, as described above.

Process 1200 may include additional aspects, such as any single aspect or any combination of aspects described below and/or in connection with one or more other processes described elsewhere herein.

In a first aspect, the first set of antenna indices and the second set of antenna indices identify PUSCH antenna ports, and the PUSCH antenna ports identify the SRS antenna ports according to a mapping of PUSCH antenna ports to SRS antenna ports.

In a second aspect, alone or in combination with the first aspect, the uplink transmission is received using the first beam or the second beam.

In a third aspect, alone or in combination with one or more of the first and second aspects, the uplink transmission is a multi-panel uplink transmission.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a determination component 1308, among other examples.

In some aspects, the apparatus 1300 may be configured to perform one or more operations described herein in connection with FIGS. 3-7. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the UE described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the UE described above in connection with FIG. 2. In some aspects, the transmission component 1304 may be co-located with the reception component 1302 in a transceiver.

The reception component 1302 may receive DCI that indicates a first TCI, a second TCI, and a precoding matrix, the first TCI being associated with a first set of antenna indices of the precoding matrix and the second TCI being associated with a second set of antenna indices of the precoding matrix. The transmission component 1304 may transmit an uplink transmission based at least in part on the DCI. The determination component 1308 may determine that the first TCI is associated with the first set of antenna indices of the precoding matrix and the second TCI is associated with the second set of antenna indices of the precoding matrix. In some aspects, the determination component 1308 may include a controller/processor, a memory, or a combination thereof, of the UE described above in connection with FIG. 2.

The reception component 1302 may receive DCI that indicates a first beam and a second beam for a first set of antenna indices and a second set of antenna indices that identify SRS antenna ports associated with multiple SRS resources of multiple SRS resource sets. The transmission component 1304 may transmit an uplink transmission based at least in part on the DCI.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

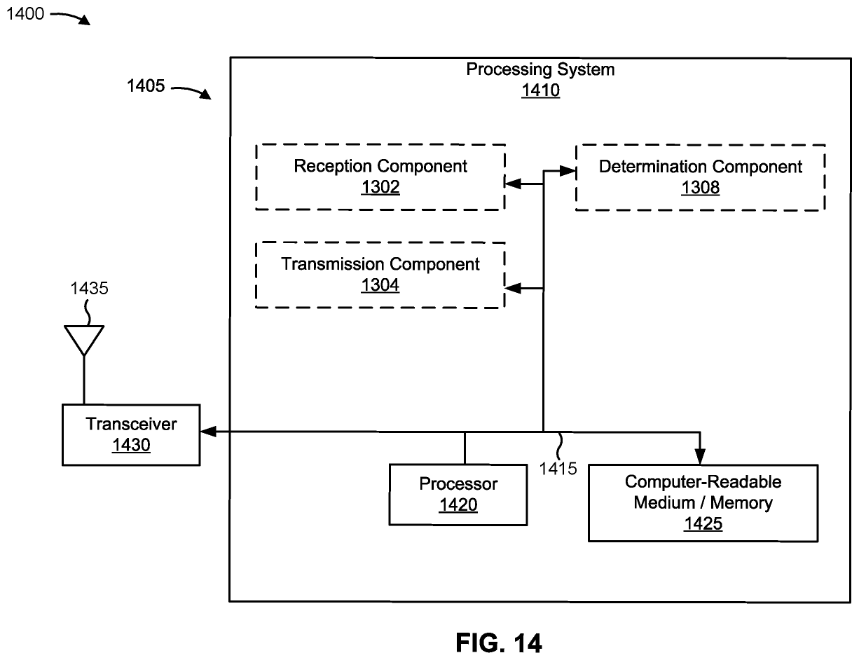

FIG. 14 is a diagram illustrating an example 1400 of a hardware implementation for an apparatus 1405 employing a processing system 1410, in accordance with the present disclosure. The apparatus 1405 may be a UE.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the UE 120 and may include the memory 282 and/or at least one of the TX MIMO processor 266, the receive processor 258, and/or the controller/processor 280. In some aspects, the apparatus 1405 for wireless communication includes means for receiving DCI that indicates a first TCI, a second TCI, and a precoding matrix, the first TCI being associated with a first set of antenna indices of the precoding matrix and the second TCI being associated with a second set of antenna indices of the precoding matrix, means for receiving DCI that indicates a first beam and a second beam for a first set of antenna indices and a second set of antenna indices that identify SRS antenna ports associated with multiple SRS resources of multiple SRS resource sets, and/or means for transmitting an uplink transmission based at least in part on DCI. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 266, the receive processor 258, and/or the controller/processor 280. In one configuration, the aforementioned means may be the TX MIMO processor 266, the receive processor 258, and/or the controller/processor 280 configured to perform the functions and/or operations recited herein.

FIG. 14 is provided as an example. Other examples may differ from what is described in connection with FIG. 14.

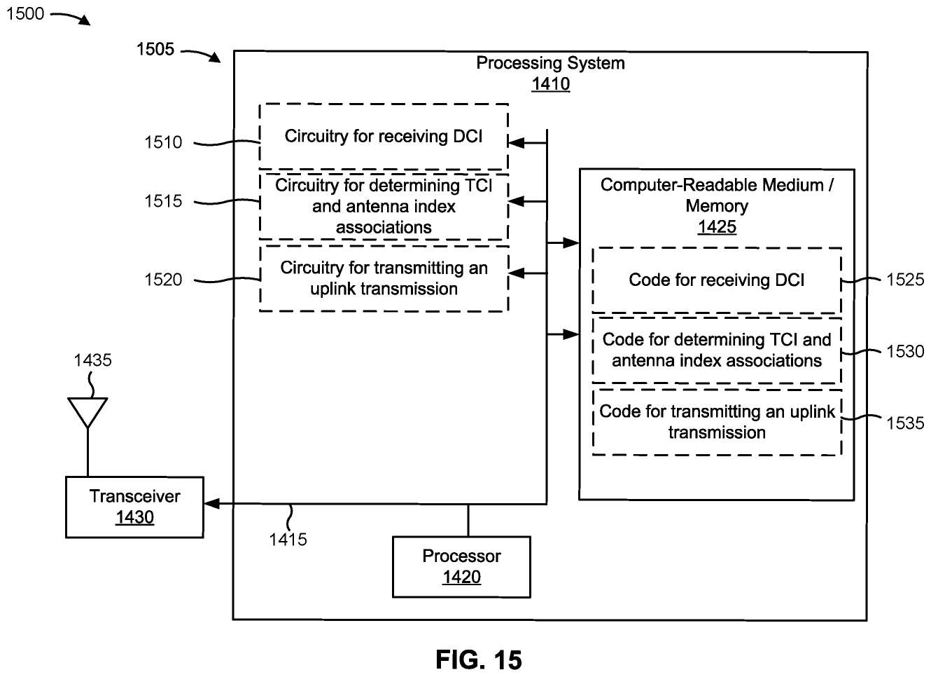

FIG. 15 is a diagram illustrating an example 1500 of an implementation of code and circuitry for an apparatus 1505, in accordance with the present disclosure. The apparatus 1505 may be a UE.

As further shown in FIG. 15, the apparatus 1505 may include circuitry for receiving DCI (circuitry 1510). For example, the apparatus 1505 may include circuitry to enable the apparatus 1505 to receive DCI that indicates a first TCI, a second TCI, and a precoding matrix, the first TCI being associated with a first set of antenna indices of the precoding matrix and the second TCI being associated with a second set of antenna indices of the precoding matrix. As another example, the apparatus 1505 may include circuitry to enable the apparatus 1505 to receive DCI that indicates a first beam and a second beam for a first set of antenna indices and a second set of antenna indices that identify SRS antenna ports associated with multiple SRS resources of multiple SRS resource sets.

As further shown in FIG. 15, the apparatus 1505 may include circuitry for determining TCI and antenna index associations (circuitry 1515). For example, the apparatus 1505 may include circuitry to enable the apparatus 1505 to determine that the first TCI is associated with the first set of antenna indices of the precoding matrix and the second TCI is associated with the second set of antenna indices of the precoding matrix.

As further shown in FIG. 15, the apparatus 1505 may include circuitry for transmitting an uplink transmission (circuitry 1520). For example, the apparatus 1505 may include circuitry to enable the apparatus 1505 to transmit an uplink transmission based at least in part on the DCI.

As further shown in FIG. 15, the apparatus 1505 may include, stored in a computer-readable medium 1425, code for receiving DCI (code 1525). For example, the apparatus 1505 may include code that, when executed by the processor 1420, may cause the processor 1420 to cause the transceiver 1430 to receive DCI that indicates a first TCI, a second TCI, and a precoding matrix, the first TCI being associated with a first set of antenna indices of the precoding matrix and the second TCI being associated with a second set of antenna indices of the precoding matrix. As another example, the apparatus 1505 may include code that, when executed by the processor 1420, may cause the processor 1420 to cause the transceiver 1430 to receive DCI that indicates a first beam and a second beam for a first set of antenna indices and a second set of antenna indices that identify SRS antenna ports associated with multiple SRS resources of multiple SRS resource sets.

As further shown in FIG. 15, the apparatus 1505 may include, stored in a computer-readable medium 1425, code for determining TCI and antenna index associations (code 1530). For example, the apparatus 1505 may include code that, when executed by the processor 1420, may cause the processor 1420 to determine that the first TCI is associated with the first set of antenna indices of the precoding matrix and the second TCI is associated with the second set of antenna indices of the precoding matrix.

As further shown in FIG. 15, the apparatus 1505 may include, stored in a computer-readable medium 1425, code for transmitting an uplink transmission (code 1535). For example, the apparatus 1505 may include code that, when executed by the processor 1420, may cause the processor 1420 to cause the transceiver 1430 to transmit an uplink transmission based at least in part on the DCI.

FIG. 15 is provided as an example. Other examples may differ from what is described in connection with FIG. 15.

FIG. 16 is a diagram of an example apparatus 1600 for wireless communication, in accordance with the present disclosure. The apparatus 1600 may be a base station, or a base station may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include a determination component 1608, among other examples.

In some aspects, the apparatus 1600 may be configured to perform one or more operations described herein in connection with FIGS. 5-7. Additionally, or alternatively, the apparatus 1600 may be configured to perform one or more processes described herein, such as process 1000 of FIG. 10, process 1200 of FIG. 12, or a combination thereof. In some aspects, the apparatus 1600 and/or one or more components shown in FIG. 16 may include one or more components of the base station described above in connection with FIG. 2. Additionally, or alternatively, one or more components shown in FIG. 16 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1606. In some aspects, the reception component 1602 may include one or more antennas, a demodulator, a MIMO detector, a receive processor, a controller/processor, a memory, or a combination thereof, of the base station described above in connection with FIG. 2.

The transmission component 1604 may transmit communications, such as reference signals, control information, data communications, or a combination thereof, to the apparatus 1606. In some aspects, one or more other components of the apparatus 1606 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modulator, a transmit MIMO processor, a transmit processor, a controller/processor, a memory, or a combination thereof, of the base station described above in connection with FIG. 2. In some aspects, the transmission component 1604 may be co-located with the reception component 1602 in a transceiver.

The transmission component 1604 may transmit DCI that indicates a first TCI, a second TCI, and a precoding matrix for a UE, the first TCI being associated with a first set of antenna indices of the precoding matrix and the second TCI being associated with a second set of antenna indices of the precoding matrix. The reception component 1602 may receive an uplink transmission from the UE based at least in part on the DCI. The determination component 1608 may determine the first TCI, the second TCI, and the precoding matrix for the UE. In some aspects, the determination component 1608 may include a controller/processor, a memory, or a combination thereof, of the base station described above in connection with FIG. 2.

The transmission component 1604 may transmit, to a UE, DCI that indicates a first beam and a second beam for a first set of antenna indices and a second set of antenna indices that identify SRS antenna ports associated with multiple SRS resources of multiple SRS resource sets. The reception component 1602 may receive an uplink transmission from the UE based at least in part on the DCI.

The quantity and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

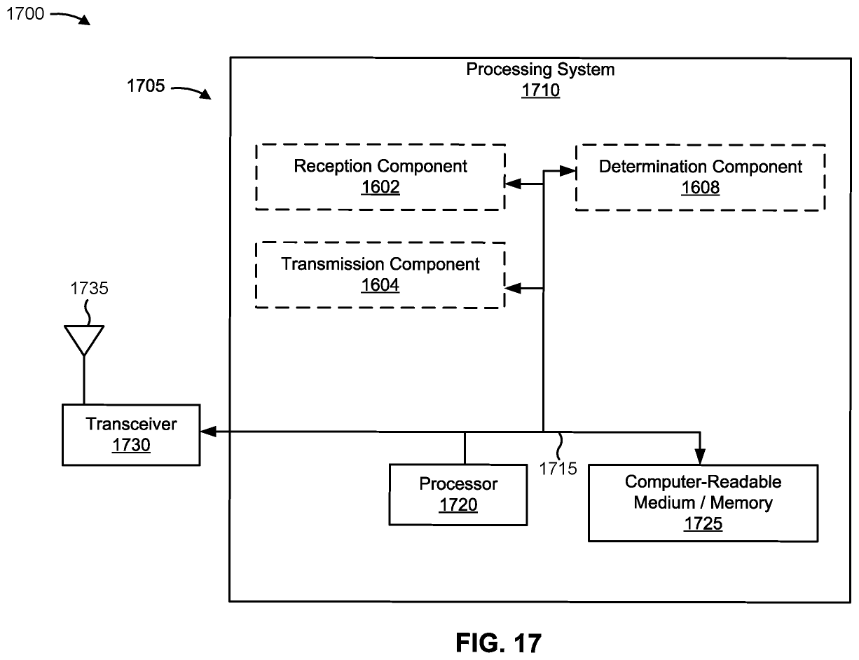

FIG. 17 is a diagram illustrating an example 1700 of a hardware implementation for an apparatus 1705 employing a processing system 1710, in accordance with the present disclosure. The apparatus 1705 may be a base station.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor 1720, the illustrated components, and the computer-readable medium/memory 1725. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the base station 110 and may include the memory 242 and/or at least one of the TX MIMO processor 230, the receive processor 238, and/or the controller/processor 240. In some aspects, the apparatus 1705 for wireless communication includes means for transmitting DCI that indicates a first TCI, a second TCI, and a precoding matrix for a UE, the first TCI being associated with a first set of antenna indices of the precoding matrix and the second TCI being associated with a second set of antenna indices of the precoding matrix, means for transmitting, to a UE, DCI that indicates a first beam and a second beam for a first set of antenna indices and a second set of antenna indices that identify SRS antenna ports associated with multiple SRS resources of multiple SRS resource sets, and/or means for receiving an uplink transmission from the UE based at least in part on the DCI. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 17 is provided as an example. Other examples may differ from what is described in connection with FIG. 17.

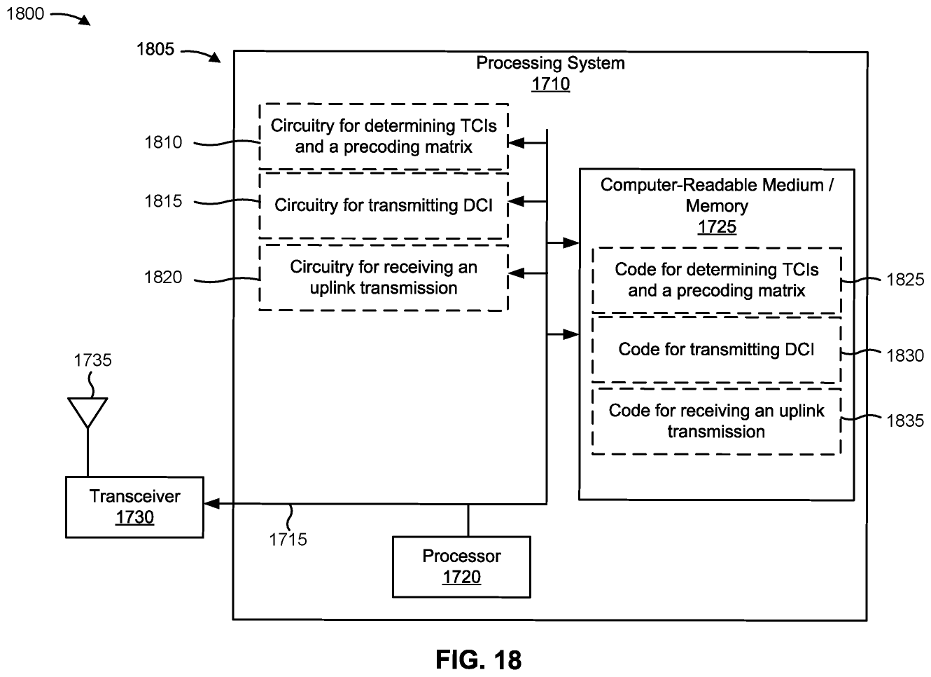

FIG. 18 is a diagram illustrating an example 1800 of an implementation of code and circuitry for an apparatus 1805, in accordance with the present disclosure. The apparatus 1805 may be a base station.

As further shown in FIG. 18, the apparatus 1805 may include circuitry for determining TCIs and a precoding matrix (circuitry 1810). For example, the apparatus 1805 may include circuitry to enable the apparatus 1805 to determine a first TCI, a second TCI, and a precoding matrix for a UE.

As further shown in FIG. 18, the apparatus 1805 may include circuitry for transmitting DCI (circuitry 1815). For example, the apparatus 1805 may include circuitry to enable the apparatus 1805 to transmit DCI that indicates the first TCI, the second TCI, and the precoding matrix for the UE, the first TCI being associated with a first set of antenna indices of the precoding matrix and the second TCI being associated with a second set of antenna indices of the precoding matrix. As another example, the apparatus 1805 may include circuitry to enable the apparatus 1805 to transmit, to a UE, DCI that indicates a first beam and a second beam for a first set of antenna indices and a second set of antenna indices that identify SRS antenna ports associated with multiple SRS resources of multiple SRS resource sets.

As further shown in FIG. 18, the apparatus 1805 may include circuitry for receiving an uplink transmission (circuitry 1820). For example, the apparatus 1805 may include circuitry to enable the apparatus 1805 to receive an uplink transmission from the UE based at least in part on the DCI.

As further shown in FIG. 18, the apparatus 1805 may include, stored in a computer-readable medium 1725, code for determining TCIs and a precoding matrix (code 1825). For example, the apparatus 1805 may include code that, when executed by the processor 1720, may cause the processor 1720 to determine a first TCI, a second TCI, and a precoding matrix for a UE.

As further shown in FIG. 18, the apparatus 1805 may include, stored in a computer-readable medium 1725, code for transmitting DCI (code 1830). For example, the apparatus 1805 may include code that, when executed by the processor 1720, may cause the processor 1720 to cause the transceiver 1730 to transmit DCI that indicates the first TCI, the second TCI, and the precoding matrix for the UE, the first TCI being associated with a first set of antenna indices of the precoding matrix and the second TCI being associated with a second set of antenna indices of the precoding matrix. As another example, the apparatus 1805 may include code that, when executed by the processor 1720, may cause the processor 1720 to cause the transceiver 1730 to transmit, to a UE, DCI that indicates a first beam and a second beam for a first set of antenna indices and a second set of antenna indices that identify SRS antenna ports associated with multiple SRS resources of multiple SRS resource sets.

As further shown in FIG. 18, the apparatus 1805 may include, stored in a computer-readable medium 1725, code for receiving an uplink transmission (code 1835). For example, the apparatus 1805 may include code that, when executed by the processor 1720, may cause the processor 1720 to cause the transceiver 1730 to receive an uplink transmission from the UE based at least in part on the DCI.

FIG. 18 is provided as an example. Other examples may differ from what is described in connection with FIG. 18.

The following provides an overview of some aspects of the present disclosure:

Aspect 1: A method of wireless communication performed by a user equipment (UE), comprising: receiving downlink control information (DCI) that indicates a first transmission configuration indicator (TCI), a second TCI, and a precoding matrix, the first TCI being associated with a first set of antenna indices of the precoding matrix and the second TCI being associated with a second set of antenna indices of the precoding matrix; and transmitting an uplink transmission based at least in part on the DCI.

Aspect 2: The method of aspect 1, wherein the first set of antenna indices and the second set of antenna indices identify physical uplink shared channel antenna ports or sounding reference signal (SRS) antenna ports.

Aspect 3: The method of aspect 2, wherein the SRS antenna ports are associated with a single SRS resource of an SRS resource set, multiple SRS resources of a single SRS resource set, or multiple SRS resources of multiple SRS resource sets.

Aspect 4: The method of any of aspects 1-3, wherein the DCI further indicates a set of demodulation reference signal (DMRS) antenna ports.

Aspect 5: The method of aspect 4, wherein layers of the precoding matrix are mapped to the set of DMRS antenna ports according to an ordering of the set of DMRS antenna ports.

Aspect 6: The method of aspect 4, wherein layers of the precoding matrix are one-to-one mapped to the set of DMRS antenna ports according to an ordering of the set of DMRS antenna ports.

Aspect 7: The method of any of aspects 1-6, wherein the precoding matrix indicates that the DCI is for a joint transmission based at least in part on a layer of the precoding matrix including a precoder for one or more antenna indices of the first set of antenna indices and one or more antenna indices of the second set of antenna indices.

Aspect 8: The method of any of aspects 1-7, wherein the first TCI and the second TCI are associated with a same code-division multiplexing group.

Aspect 9: The method of any of aspects 1-6, wherein the precoding matrix indicates that the DCI is for a non-coherent joint transmission based at least in part on a first layer of the precoding matrix including a precoder for one or more antenna indices of the first set of antenna indices and not including a precoder for one or more antenna indices of the second set of antenna indices, and a second layer of the precoding matrix including a precoder for one or more antenna indices of the second set of antenna indices and not including a precoder for one or more antenna indices of the first set of antenna indices.

Aspect 10: The method of any of aspects 1-6 and 9, wherein the first TCI is associated with a first code-division multiplexing (CDM) group, and the second TCI is associated with a second CDM group.

Aspect 11: The method of any of aspects 1-6, wherein the precoding matrix indicates that the DCI is for a dynamic panel selection based at least in part on all layers of the precoding matrix including a precoder for one or more antenna indices of one of the first set of antenna indices or the second set of antenna indices, and not including a precoder for one or more antenna indices of the other of the first set of antenna indices or the second set of antenna indices.

Aspect 12: The method of any of aspects 1-6 and 11, wherein the first TCI or the second TCI is associated with a code-division multiplexing group.

Aspect 13: A method of wireless communication performed by a base station, comprising: transmitting downlink control information (DCI) that indicates a first transmission configuration indicator (TCI), a second TCI, and a precoding matrix for a user equipment (UE), the first TCI being associated with a first set of antenna indices of the precoding matrix and the second TCI being associated with a second set of antenna indices of the precoding matrix; and receiving an uplink transmission from the UE based at least in part on the DCI.

Aspect 14: The method of aspect 13, wherein the first set of antenna indices and the second set of antenna indices identify physical uplink shared channel antenna ports or sounding reference signal (SRS) antenna ports.

Aspect 15: The method of aspect 14, wherein the SRS antenna ports are associated with a single SRS resource of an SRS resource set, multiple SRS resources of a single SRS resource set, or multiple SRS resources of multiple SRS resource sets.

Aspect 16: The method of any of aspects 13-15, wherein the DCI further indicates a set of demodulation reference signal (DMRS) antenna ports.

Aspect 17: The method of aspect 16, wherein layers of the precoding matrix are mapped to the set of DMRS antenna ports according to an ordering of the set of DMRS antenna ports.

Aspect 18: The method of aspect 16, wherein layers of the precoding matrix are one-to-one mapped to the set of DMRS antenna ports according to an ordering of the set of DMRS antenna ports.

Aspect 19: The method of any of aspects 13-18, wherein the precoding matrix indicates that the DCI is for a joint transmission based at least in part on a layer of the precoding matrix including a precoder for one or more antenna indices of the first set of antenna indices and one or more antenna indices of the second set of antenna indices.

Aspect 20: The method of any of aspects 13-19, wherein the first TCI and the second TCI are associated with a same code-division multiplexing group.

Aspect 21: The method of any of aspects 13-18, wherein the precoding matrix indicates that the DCI is for a non-coherent joint transmission based at least in part on a first layer of the precoding matrix including a precoder for one or more antenna indices of the first set of antenna indices and not including a precoder for one or more antenna indices of the second set of antenna indices, and a second layer of the precoding matrix including a precoder for one or more antenna indices of the second set of antenna indices and not including a precoder for one or more antenna indices of the first set of antenna indices.

Aspect 22: The method of any of aspects 13-18 and 21, wherein the first TCI is associated with a first code-division multiplexing (CDM) group, and the second TCI is associated with a second CDM group.

Aspect 23: The method of any of aspects 13-18, wherein the precoding matrix indicates that the DCI is for a dynamic panel selection based at least in part on all layers of the precoding matrix including a precoder for one or more antenna indices of one of the first set of antenna indices or the second set of antenna indices, and not including a precoder for one or more antenna indices of the other of the first set of antenna indices or the second set of antenna indices.

Aspect 24: The method of any of aspects 13-18 and 23, wherein the first TCI or the second TCI is associated with a code-division multiplexing group.

Aspect 25: A method of wireless communication performed by a user equipment (UE), comprising: receiving downlink control information (DCI) that indicates a first beam and a second beam for a first set of antenna indices and a second set of antenna indices that identify sounding reference signal (SRS) antenna ports associated with multiple SRS resources of multiple SRS resource sets; and transmitting an uplink transmission based at least in part on the DCI.

Aspect 26: The method of aspect 25, wherein the first set of antenna indices and the second set of antenna indices identify physical uplink shared channel (PUSCH) antenna ports, and the PUSCH antenna ports identify the SRS antenna ports according to a mapping of PUSCH antenna ports to SRS antenna ports.

Aspect 27: The method of aspect 25, wherein the first set of antenna indices and the second set of antenna indices identify physical uplink shared channel (PUSCH) antenna ports, and the PUSCH antenna ports identify the SRS antenna ports according to a one-to-one mapping of PUSCH antenna ports to SRS antenna ports.

Aspect 28: The method of any of aspects 25-27, wherein the uplink transmission is transmitted using the first beam and the second beam.

Aspect 29: The method of any of aspects 25-28, wherein the uplink transmission is a multi-panel uplink transmission.

Aspect 30: A method of wireless communication performed by a base station, comprising: transmitting, to a user equipment (UE), downlink control information (DCI) that indicates a first beam and a second beam for a first set of antenna indices and a second set of antenna indices that identify sounding reference signal (SRS) antenna ports associated with multiple SRS resources of multiple SRS resource sets; and receiving an uplink transmission from the UE based at least in part on the DCI.

Aspect 31: The method of aspect 30, wherein the first set of antenna indices and the second set of antenna indices identify physical uplink shared channel (PUSCH) antenna ports, and the PUSCH antenna ports identify the SRS antenna ports according to a mapping of PUSCH antenna ports to SRS antenna ports.

Aspect 32: The method of aspect 30, wherein the first set of antenna indices and the second set of antenna indices identify physical uplink shared channel (PUSCH) antenna ports, and the PUSCH antenna ports identify the SRS antenna ports according to a one-to-one mapping of PUSCH antenna ports to SRS antenna ports.

Aspect 33: The method of any of aspects 30-32, wherein the uplink transmission is received using the first beam or the second beam.

Aspect 34: The method of any of aspects 30-33, wherein the uplink transmission is a multi-panel uplink transmission.

Aspect 35: An apparatus for wireless communication at a device, comprising a processor; memory coupled with the processor; and instructions stored in the memory and executable by the processor to cause the apparatus to perform the method of one or more aspects of aspects 1-12.

Aspect 36: A device for wireless communication, comprising a memory and one or more processors coupled to the memory, the memory and the one or more processors configured to perform the method of one or more aspects of aspects 1-12.

Aspect 37: An apparatus for wireless communication, comprising at least one means for performing the method of one or more aspects of aspects 1-12.

Aspect 38: A non-transitory computer-readable medium storing code for wireless communication, the code comprising instructions executable by a processor to perform the method of one or more aspects of aspects 1-12.

Aspect 39: A non-transitory computer-readable medium storing a set of instructions for wireless communication, the set of instructions comprising one or more instructions that, when executed by one or more processors of a device, cause the device to perform the method of one or more aspects of aspects 1-12.

Aspect 40: An apparatus for wireless communication at a device, comprising a processor; memory coupled with the processor; and instructions stored in the memory and executable by the processor to cause the apparatus to perform the method of one or more aspects of aspects 13-24.

Aspect 41: A device for wireless communication, comprising a memory and one or more processors coupled to the memory, the memory and the one or more processors configured to perform the method of one or more aspects of aspects 13-24.

Aspect 42: An apparatus for wireless communication, comprising at least one means for performing the method of one or more aspects of aspects 13-24.

Aspect 43: A non-transitory computer-readable medium storing code for wireless communication, the code comprising instructions executable by a processor to perform the method of one or more aspects of aspects 13-24.

Aspect 44: A non-transitory computer-readable medium storing a set of instructions for wireless communication, the set of instructions comprising one or more instructions that, when executed by one or more processors of a device, cause the device to perform the method of one or more aspects of aspects 13-24.

Aspect 45: An apparatus for wireless communication at a device, comprising a processor; memory coupled with the processor; and instructions stored in the memory and executable by the processor to cause the apparatus to perform the method of one or more aspects of aspects 25-29.

Aspect 46: A device for wireless communication, comprising a memory and one or more processors coupled to the memory, the memory and the one or more processors configured to perform the method of one or more aspects of aspects 25-29.

Aspect 47: An apparatus for wireless communication, comprising at least one means for performing the method of one or more aspects of aspects 25-29.

Aspect 48: A non-transitory computer-readable medium storing code for wireless communication, the code comprising instructions executable by a processor to perform the method of one or more aspects of aspects 25-29.

Aspect 49: A non-transitory computer-readable medium storing a set of instructions for wireless communication, the set of instructions comprising one or more instructions that, when executed by one or more processors of a device, cause the device to perform the method of one or more aspects of aspects 25-29.

Aspect 50: An apparatus for wireless communication at a device, comprising a processor; memory coupled with the processor; and instructions stored in the memory and executable by the processor to cause the apparatus to perform the method of one or more aspects of aspects 30-34.

Aspect 51: A device for wireless communication, comprising a memory and one or more processors coupled to the memory, the memory and the one or more processors configured to perform the method of one or more aspects of aspects 30-34.

Aspect 52: An apparatus for wireless communication, comprising at least one means for performing the method of one or more aspects of aspects 30-34.

Aspect 53: A non-transitory computer-readable medium storing code for wireless communication, the code comprising instructions executable by a processor to perform the method of one or more aspects of aspects 30-34.

Aspect 54: A non-transitory computer-readable medium storing a set of instructions for wireless communication, the set of instructions comprising one or more instructions that, when executed by one or more processors of a device, cause the device to perform the method of one or more aspects of aspects 30-34.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors coupled to the memory, the memory and the one or more processors configured to:
receive downlink control information (DCI) that indicates a first transmission configuration indicator (TCI), a second TCI, and a precoding matrix, the first TCI being associated with a first set of antenna indices of the precoding matrix and the second TCI being associated with a second set of antenna indices of the precoding matrix; and
transmit an uplink transmission based at least in part on the DCI.

2. The UE of claim 1, wherein the first set of antenna indices and the second set of antenna indices identify physical uplink shared channel antenna ports or sounding reference signal (SRS) antenna ports.

3. The UE of claim 2, wherein the SRS antenna ports are associated with a single SRS resource of an SRS resource set, multiple SRS resources of a single SRS resource set, or multiple SRS resources of multiple SRS resource sets.

4. The UE of claim 1, wherein the DCI further indicates a set of demodulation reference signal (DMRS) antenna ports.

5. The UE of claim 4, wherein layers of the precoding matrix are mapped to the set of DMRS antenna ports according to an ordering of the set of DMRS antenna ports.

6. The UE of claim 1, wherein the precoding matrix indicates that the DCI is for a joint transmission based at least in part on a layer of the precoding matrix including a precoder for one or more antenna indices of the first set of antenna indices and one or more antenna indices of the second set of antenna indices.

7. The UE of claim 1, wherein the first TCI and the second TCI are associated with a same code-division multiplexing group.

8. The UE of claim 1, wherein the precoding matrix indicates that the DCI is for a non-coherent joint transmission based at least in part on a first layer of the precoding matrix including a precoder for one or more antenna indices of the first set of antenna indices and not including a precoder for one or more antenna indices of the second set of antenna indices, and a second layer of the precoding matrix including a precoder for one or more antenna indices of the second set of antenna indices and not including a precoder for one or more antenna indices of the first set of antenna indices.

9. The UE of claim 1, wherein the first TCI is associated with a first code-division multiplexing (CDM) group, and the second TCI is associated with a second CDM group.

10. The UE of claim 1, wherein the precoding matrix indicates that the DCI is for a dynamic panel selection based at least in part on all layers of the precoding matrix including a precoder for one or more antenna indices of one of the first set of antenna indices or the second set of antenna indices, and not including a precoder for one or more antenna indices of the other of the first set of antenna indices or the second set of antenna indices.

11. The UE of claim 1, wherein the first TCI or the second TCI is associated with a code-division multiplexing group.

12. A base station for wireless communication, comprising:
a memory; and
one or more processors coupled to the memory, the memory and the one or more processors configured to:
transmit downlink control information (DCI) that indicates a first transmission configuration indicator (TCI), a second TCI, and a precoding matrix for a user equipment (UE), the first TCI being associated with a first set of antenna indices of the precoding matrix and the second TCI being associated with a second set of antenna indices of the precoding matrix; and
receive an uplink transmission from the UE based at least in part on the DCI.

13. The base station of claim 12, wherein the first set of antenna indices and the second set of antenna indices identify physical uplink shared channel antenna ports or sounding reference signal (SRS) antenna ports.

14. The base station of claim 13, wherein the SRS antenna ports are associated with a single SRS resource of an SRS resource set, multiple SRS resources of a single SRS resource set, or multiple SRS resources of multiple SRS resource sets.

15. The base station of claim 12, wherein the DCI further indicates a set of demodulation reference signal (DMRS) antenna ports.

16. The base station of claim 15, wherein layers of the precoding matrix are mapped to the set of DMRS antenna ports according to an ordering of the set of DMRS antenna ports.

17. The base station of claim 12, wherein the precoding matrix indicates that the DCI is for a joint transmission based at least in part on a layer of the precoding matrix including a precoder for one or more antenna indices of the first set of antenna indices and one or more antenna indices of the second set of antenna indices.

18. The base station of claim 12, wherein the first TCI and the second TCI are associated with a same code-division multiplexing group.

19. The base station of claim 12, wherein the precoding matrix indicates that the DCI is for a non-coherent joint transmission based at least in part on a first layer of the precoding matrix including a precoder for one or more antenna indices of the first set of antenna indices and not including a precoder for one or more antenna indices of the second set of antenna indices, and a second layer of the precoding matrix including a precoder for one or more antenna indices of the second set of antenna indices and not including a precoder for one or more antenna indices of the first set of antenna indices.

20. The base station of claim 12, wherein the first TCI is associated with a first code-division multiplexing (CDM) group, and the second TCI is associated with a second CDM group.

21. The base station of claim 12, wherein the precoding matrix indicates that the DCI is for a dynamic panel selection based at least in part on all layers of the precoding matrix including a precoder for one or more antenna indices of one of the first set of antenna indices or the second set of antenna indices, and not including a precoder for one or more antenna indices of the other of the first set of antenna indices or the second set of antenna indices.

22. The base station of claim 12, wherein the first TCI or the second TCI is associated with a code-division multiplexing group.

23. A user equipment (UE) for wireless communication, comprising:
a memory; and
one or more processors coupled to the memory, the memory and the one or more processors configured to:
receive downlink control information (DCI) that indicates a first beam and a second beam for a first set of antenna indices and a second set of antenna indices that identify sounding reference signal (SRS) antenna ports associated with multiple SRS resources of multiple SRS resource sets; and
transmit an uplink transmission based at least in part on the DCI.

24. The UE of claim 23, wherein the first set of antenna indices and the second set of antenna indices identify physical uplink shared channel (PUSCH) antenna ports, and the PUSCH antenna ports identify the SRS antenna ports according to a mapping of PUSCH antenna ports to SRS antenna ports.

25. The UE of claim 23, wherein the memory and the one or more processors, when transmitting an uplink transmission based at least in part on the DCI, are configured to transmit the uplink transmission using the first beam and the second beam.

26. The UE of claim 23, wherein the uplink transmission is a multi-panel uplink transmission.

27. A base station for wireless communication, comprising:
a memory; and
one or more processors coupled to the memory, the memory and the one or more processors configured to:
transmit, to a user equipment (UE), downlink control information (DCI) that indicates a first beam and a second beam for a first set of antenna indices and a second set of antenna indices that identify sounding reference signal (SRS) antenna ports associated with multiple SRS resources of multiple SRS resource sets; and
receive an uplink transmission from the UE based at least in part on the DCI.

28. The base station of claim 27, wherein the first set of antenna indices and the second set of antenna indices identify physical uplink shared channel (PUSCH) antenna ports, and the PUSCH antenna ports identify the SRS antenna ports according to a mapping of PUSCH antenna ports to SRS antenna ports.

29. The base station of claim 27, wherein the memory and the one or more processors, when receiving an uplink transmission from the UE based at least in part on the DCI, are configured to receive the uplink transmission using the first beam or the second beam.

30. The base station of claim 27, wherein the uplink transmission is a multi-panel uplink transmission.
